(19) United States
(12) Patent Application Publication
(10) Pub. No.: US 2018/0299193 A1
(43) Pub. Date: Oct. 18, 2018

(54) Integrated Dry Ice Production and Storage System

(71) Applicant: Tokitae LLC, Bellevue, WA (US)

(72) Inventors: Stephen Thomas Graves Burkot, Bellevue, WA (US); Mark K. Kuiper, Seattle, WA (US); Daniel Howard Lieberman, Bellevue, WA (US); Chin Hei Ng, Newcastle, WA (US); Nicholas John Schwampe, Seattle, WA (US); David J. Yager, Carnation, WA (US)

(73) Assignee: TOKITAE LLC.

(21) Appl. No.: 15/485,550

(22) Filed: Apr. 12, 2017

(51) Int. Cl. F25J 1/00; F25J 1/02

(52) U.S. Cl. CPC F25J 1/0095; F25J 1/0027; C01B 31/22; F25J 1/0275

(57) ABSTRACT

Devices and systems for dry ice production are described, including a lid structure sized for placement over a storage container, an input tube sized to traverse a first opening in the lid structure and forming a flow conduit for pressurized carbon dioxide into the storage container, a vent tube sized to traverse a second opening in the lid structure and forming a flow conduit for gaseous carbon dioxide, a first end of the vent tube sized to fit into the storage container, a lower vent tube sized to fit in the storage container, the lower vent tube coupled to the first end of the vent tube and having openings to vent gaseous carbon dioxide from the storage container and into the vent tube.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)).

### PRIORITY APPLICATIONS

None

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

In an aspect, a device for dry ice production includes, but is not limited to, a lid structure sized for placement over an opening to a storage container, the lid structure defining a first opening and a second opening; an input tube sized to traverse at least partially through the first opening defined by the lid structure, the input tube having a first end and a second end forming a flow conduit for pressurized carbon dioxide into the storage container, the first end of the input tube having a coupling for attachment to a source of carbon dioxide, the second end of the input tube traversing at least partially through the first opening defined by the lid structure and including at least one aperture having a diameter smaller than an inner diameter of the input tube; and a vent tube sized to pass through and seal within the second opening defined by the lid structure, the vent tube having a first end and a second end forming a flow conduit for gaseous carbon dioxide out of the storage container, the first end of the vent tube sized to fit within the storage container and to couple with a lower vent tube. In addition to the foregoing, other device aspects are described in the claims, drawings, and text forming a part of the present disclosure.

In an aspect, a system for dry ice production includes, but is not limited to, a lid structure sized for placement over an opening to a storage container, the lid structure defining a first opening and a second opening; an input tube sized to traverse at least partially through the first opening defined by the lid structure, the input tube having a first end and a second end forming a flow conduit for pressurized carbon dioxide into the storage container, the first end of the input tube having a coupling for attachment to a source of carbon dioxide, the second end of the input tube traversing at least partially through the first opening defined by the lid structure and including at least one aperture having a diameter smaller than an inner diameter of the input tube; a vent tube sized to pass through and seal within the second opening defined by the lid structure, the vent tube having a first end and a second end forming a flow conduit for gaseous carbon dioxide, the first end of the vent tube sized to fit into the storage container; and a lower vent tube sized to extend into an interior portion of the storage container, the lower vent tube having an open first end sized to couple to the first end of the vent tube, a wall of the lower vent tube defining a plurality of openings sized to allow passage of the gaseous carbon dioxide from the storage container, through the lower vent tube, and out the vent tube. In addition to the foregoing, other system aspects are described in the claims, drawings, and text forming a part of the present disclosure.

In an aspect, a device for dry ice production includes, but is not limited to, a lid structure and a vent tube formed as a single manufactured unit, wherein the lid structure has a top surface and a bottom surface, the bottom surface sized for placement over an opening to a storage container, the lid structure defining a first opening with a diameter configured to accept an input tube attached to a source of carbon dioxide, and wherein the vent tube defines a second opening through the lid structure and has a first end and a second end forming a flow conduit for gaseous carbon dioxide out of the storage container, the first end of the vent tube extending beyond the bottom surface of the lid structure and sized to fit within the storage container and couple with a lower vent tube, the second end of the vent tube extending beyond the top surface of the lid structure. In addition to the foregoing, other device aspects are described in the claims, drawings, and text forming a part of the present disclosure.

In an aspect, a system for dry ice production includes, but is not limited to, a lid structure sized for placement over an opening to a storage container, the lid structure defining an opening; a vent tube sized to pass through and seal within the opening defined by the lid structure, the vent tube having a first end and a second end forming a flow conduit for gaseous carbon dioxide, the first end of the vent tube sized to fit into the opening to the storage container; a lower vent tube sized to extend into an interior portion of the storage container, the lower vent tube having a first end sized to couple to the first end of the vent tube, and a wall of the lower vent tube defining a plurality of openings sized to allow passage of gaseous carbon dioxide from the storage container, through the lower vent tube, and out the vent tube; and an input tube sized to traverse through an interior portion of the vent tube, the input tube having a first end and a second end forming a flow conduit for pressurized carbon dioxide into the storage container, the first end of the input tube having a coupling for attachment to a source of carbon dioxide, the second end of the input tube sized to extend beyond the second end of the lower vent tube and including at least one aperture having a diameter smaller than an inner diameter of the input tube. In addition to the foregoing, other system aspects are described in the claims, drawings, and text forming a part of the present disclosure.

In an aspect, a device for dry ice production includes, but is not limited to, a lid structure having a top surface and a bottom surface, the bottom surface of the lid structure sized for placement over an opening to a storage container, the lid structure defining a first opening and a second opening, the first opening forming a flow conduit through the lid structure from the top surface to the bottom surface, the first opening having at or near the top surface of the lid structure an attachment site for an input tube attached to a source of carbon dioxide, wherein an inner diameter of the first opening at or near the bottom surface of the lid structure is smaller than an inner diameter of the first opening at or near the top surface of the lid structure; and a vent tube sized to pass through and seal within the second opening defined by the lid structure, the vent tube having a first end and a second end forming a flow conduit for gaseous carbon dioxide, the first end of the vent tube sized to fit into the opening to the storage container. In addition to the foregoing, other device aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 shows a diagram of an embodiment of a dry ice production system.

FIG. 2 shows a side view of an embodiment of a device for dry ice production.

FIG. 3 shows a side view of an embodiment of a device for dry ice production.

FIG. 4 shows a side view of an embodiment of a device for dry ice production.

FIG. 5A shows a side view of an embodiment of a device for dry ice production.

FIG. 5B is a cross-section view showing further aspects of an embodiment of a device for dry ice production such as shown in FIG. 5A.

FIG. 6 shows a side view of an embodiment of a device for dry ice production with a bend.

FIG. 7 shows a side view of an embodiment of a device for dry ice production with an attached vent sock.

FIG. 8 shows a side view of an embodiment of a device for dry ice production with a deflector.

FIG. 9 shows a side view of an embodiment of a device for dry ice production including a lower vent tube.

FIG. 10 shows a side view of an embodiment of a lower vent tube.

FIG. 11 shows a side view of an embodiment of a lower vent tube.

FIG. 12 shows a side view of an embodiment a lower vent tube with a porous or mesh material.

FIG. 13 is a side view showing further aspects of an embodiment of a device for dry ice production such as shown in FIG. 6.

FIG. 14 illustrates cross-section side view of an embodiment of a storage tube including at least one sample holder.

FIG. 15 illustrates a side view of an embodiment of a system for dry ice production.

FIG. 16 illustrates a side view of an embodiment of a system for dry ice production.

FIG. 17 shows a side view of an embodiment of a device for dry ice production.

FIG. 18 is a cross-section view through an embodiment of a device for dry ice production such as shown in FIG. 17.

FIG. 19 is a cross-section view through an embodiment of a device for dry ice production such as shown in FIG. 17 and including an input tube.

FIG. 20 is a cross-section view through an embodiment of a device for dry ice production such as shown in FIG. 17 and including an input tube and a lower vent tube with a porous or mesh material.

FIG. 21 shows a side view of an embodiment of a device for dry ice production.

FIG. 22 is a cross-section view through an embodiment of a device for dry ice production such as shown in FIG. 21.

FIG. 23A shows a side view of an embodiment of a system for dry ice production.

FIG. 23B is a cross-section view through an embodiment of a system for dry ice production such as shown in FIG. 23A.

FIG. 24 shows cross-section of an embodiment of a lid structure and a vent tube formed as a single manufactured unit for use in a system for dry ice production such as shown in FIGS. 23A and 23B.

FIG. 25 shows cross-section of an embodiment of a device for dry ice production.

FIG. 26 shows cross-section of an embodiment of a device for dry ice production.

FIG. 27 shows cross-section of an embodiment of a device for dry ice production.

FIG. 28A is a photograph showing a device for dry ice production.

FIG. 28B is a photograph showing a device for dry ice production including formed dry ice.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In many countries, there is a need for a safe, simple, and efficient means for generating dry ice for use in short term storage and transport of temperature sensitive materials. Described herein are devices and systems for safely and efficiently producing dry ice directly into a standard insulated storage container intended for short term storage and transport of biological samples (e.g., straws of bull semen for artificial insemination or vials/ampules of vaccine for vaccination).

Dry ice is the solid form of carbon dioxide (CO₂). It is extremely cold (−78.5° C.) and as such is useful for cooling and freezing of temperature sensitive materials. Dry ice can be formed through a process of deposition, wherein carbon dioxide changes from a gas to a solid phase. When liquid carbon dioxide is released from a pressurized tank, it quickly expands and evaporates, cooling some of the carbon dioxide down to its freezing point (−78.5° C.) causing it to become solid flakes of “snow.” This solid snow can be compressed together to form blocks, pellets, or other more densely packed forms of dry ice. Under normal atmospheric conditions, dry ice undergoes the process of sublimation, transitioning directly from solid back to gaseous form. At room temperature and atmospheric pressure, dry ice sublimates at a rate of approximately 5 to 10 pounds every 24 hours. The rate of dry ice sublimation can be reduced by storing the dry ice in an insulated storage container.

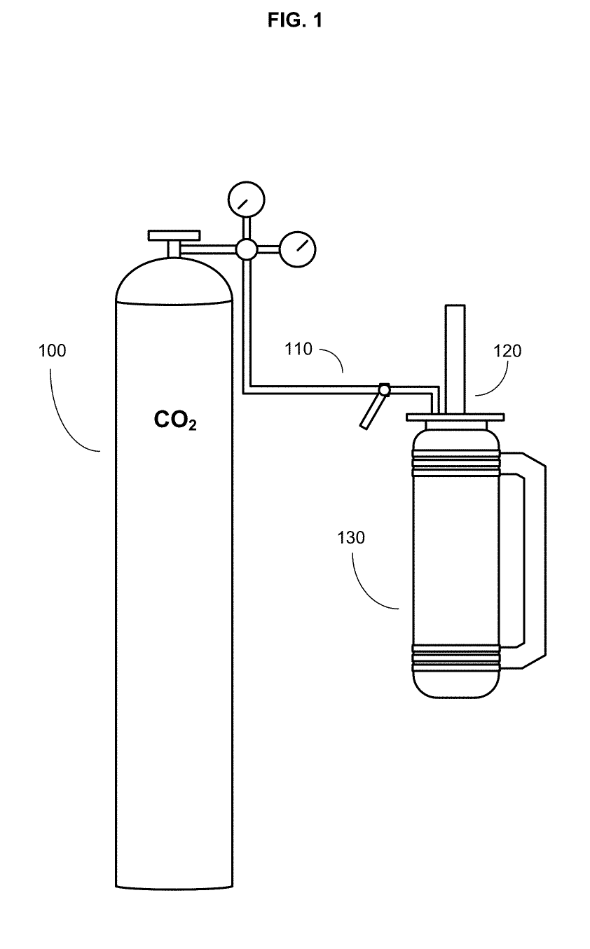

With reference to FIG. 1, shown is a non-limiting example of a dry ice production system, which can serve as a context for one or more devices and/or systems described herein. Shown is a cylinder 100 of compressed carbon dioxide (CO₂). The cylinder 100 is connected to device 120 through tubing 110. Device 120 is positioned on top of an opening to an insulated storage container 130. Device 120 is designed to receive carbon dioxide from cylinder 100 through an input tube connected to tubing 110, pass it through a small diameter aperture, and form dry ice “snow” inside the storage container 130. Once the storage container 130 is filled with dry ice, at least a portion of device 120 is removed, and a lid or cap can be attached or screwed on to the storage container 130.

In some embodiments, a device for dry ice production includes: a lid structure sized for placement over an opening to a storage container, the lid structure defining a first opening and a second opening; an input tube sized to traverse at least partially through the first opening defined by the lid structure, the input tube having a first end and a second end forming a flow conduit for pressurized carbon dioxide into the storage container, the first end of the input tube having a coupling for attachment to a source of carbon dioxide, the second end of the input tube traversing at least partially through the first opening defined by the lid structure and including at least one aperture having a diameter smaller than an inner diameter of the input tube; and a vent tube sized to pass through and seal within the second opening defined by the lid structure, the vent tube having a first end and a second end forming a flow conduit for gaseous carbon dioxide out of the storage container, the first end of the vent tube sized to fit within the storage container and to couple with a lower vent tube.

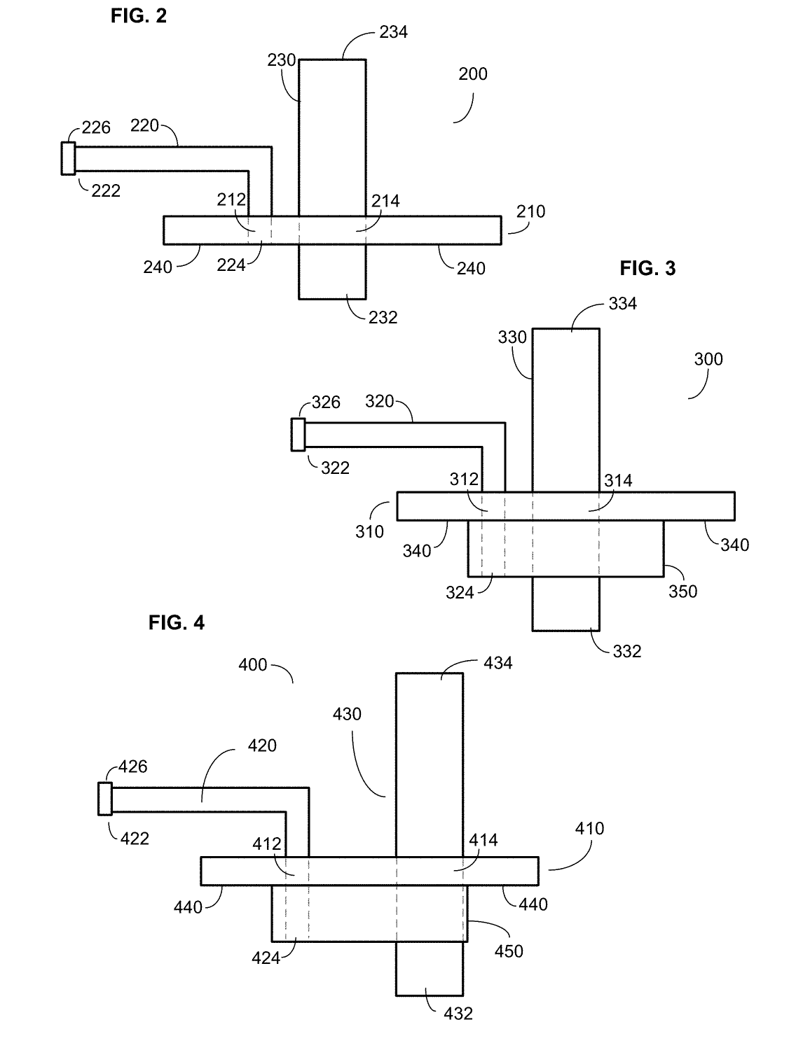

FIGS. 2-4 illustrate non-limiting embodiments of devices for dry ice production. FIG. 2 is a line drawing showing a side view of device 200. Device 200 includes lid structure 210 sized for placement over an opening to a storage container. In an aspect, the bottom surface 240 of the lid structure 210 is configured to come in contact with a lip or rim associated with the opening to the storage container. The lid structure further defines a first opening 212 and a second opening 214 (shown symbolically as area between dashed lines through lid structure 210). Device 200 includes input tube 220 sized to traverse at least partially through the first opening 212 defined by lid structure 210. Input tube 220 has a first end 222 and a second end 224 forming a flow conduit for pressurized carbon dioxide into the storage container. The first end 222 of the input tube 220 includes a coupling 226 for attachment to a source of carbon dioxide. The second end 224 of the input tube 220 traverses at least partially through the first opening 212 defined by the lid structure 210. The second end 224 of input tube 220 further includes at least one aperture (not shown) having a diameter smaller than an inner diameter of the input tube 220. Device 200 further includes vent tube 230 sized to pass through and seal within the second opening 214 defined by the lid structure 210. The vent tube 230 has a first end 232 and a second end 234 forming a flow conduit for gaseous carbon dioxide out of the storage container. The first end 232 of the vent tube 230 is sized to fit within the storage container and to couple with a lower vent tube (not shown). In this non-limiting embodiment, the vent tube 230 is positioned in approximately the center of lid structure 210.

FIG. 3 is a line drawing showing a side view of device 300. Device 300 includes lid structure 310 sized for placement over an opening to a storage container. In an aspect, the bottom surface 340 of the lid structure 310 is configured to come in contact with a lip or rim associated with the opening to the storage container. In this non-limiting embodiment, lid structure 310 further includes a lower portion 350 sized to fit into the opening of the storage container. The lower portion 350 can be sized to center device 300 in the opening of the storage container. The lid structure 310 including lower portion 350 further defines a first opening 312 and a second opening 314 (shown symbolically as area between dashed lines through lid structure 310 and lower portion 350). In this non-limiting embodiment, both the first opening 312 and the second opening 314 pass through the entirety of the lid structure 310 and the lower portion 350 of the lid structure 310. Device 300 includes input tube 320 sized to traverse at least partially through the first opening 312 defined by lid structure 310. Input tube 320 has a first end 322 and a second end 324 forming a flow conduit for pressurized carbon dioxide into the storage container. The first end 322 of the input tube 320 includes a coupling 326 for attachment to a source of carbon dioxide. The second end 324 of the input tube 320 traverses at least partially through the first opening 312 defined by the lid structure 310. The second end 324 of input tube 320 further includes at least one aperture (not shown) having a diameter smaller than an inner diameter of the input tube 320. Device 300 further includes vent tube 330 sized to pass through and seal within the second opening 314 defined by the lid structure 310. The vent tube 330 has a first end 332 and a second end 334 forming a flow conduit for gaseous carbon dioxide out of the storage container. The first end 332 of the vent tube 330 is sized to fit within the storage container and to couple with a lower vent tube (not shown). In this non-limiting embodiment, the vent tube 330 is positioned in approximately the center of lid structure 310.

FIG. 4 is a line drawing showing a side view of device 400. Device 400 includes lid structure 410 sized for placement over an opening to a storage container. In an aspect, the bottom surface 440 of the lid structure 410 is configured to come in contact with a lip or rim associated with the opening to the storage container. In this non-limiting embodiment, lid structure 410 further includes a lower portion 450 sized to fit into the opening of the storage container. The lid structure 410 including lower portion 450 further defines a first opening 412 and a second opening 414 (shown symbolically as area between dashed lines through lid structure 410 and lower portion 450). In this non-limiting embodiment, both the first opening 412 and the second opening 414 pass through the entirety of the lid structure 410 and the lower portion 450 of the lid structure 410. Device 400 includes input tube 420 sized to traverse at least partially through the first opening 412 defined by lid structure 410. Input tube 420 has a first end 422 and a second end 424 forming a flow conduit for pressurized carbon dioxide into the storage container. The first end 422 of the input tube 420 includes a coupling 426 for attachment to a source of carbon dioxide, the second end 424 of the input tube 420 traversing at least partially through the first opening 412 defined by the lid structure 410. The second end 424 of input tube 420 further includes at least one aperture (not shown) having a diameter smaller than an inner diameter of the input tube 420. Device 400 further includes vent tube 430 sized to pass through and seal within the second opening 414 defined by the lid structure 410. The vent tube 430 has a first end 432 and a second end 434 forming a flow conduit for gaseous carbon dioxide out of the storage container. The first end 432 of the vent tube 430 is sized to fit within the storage container and to couple with a lower vent tube (not shown). In this non-limiting embodiment, the vent tube 430 is off-center and positioned towards an edge of lid structure 410 away from input tube 420.

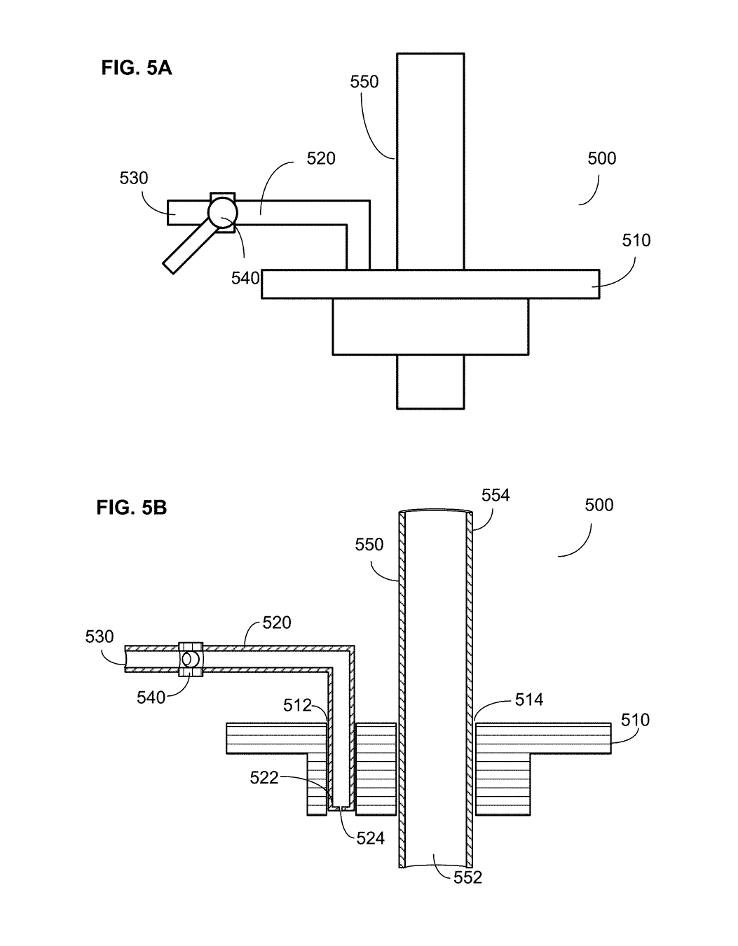

FIGS. 5A and 5B illustrate further aspects of a device for dry ice production. FIG. 5A shows a side view of device 500 including lid structure 510, input tube 520, and vent tube 550. In some embodiments, a device for dry ice production further includes a valve positioned between the first end and the second end of the input tube. FIG. 5A shows device 500 including a valve 540 positioned between the first end 530 and the second end (not shown) of the input tube 520. In an aspect, the valve 540 positioned between the first end 530 and the second end of the input tube 520 comprises a ball valve with a spring return handle. The valve is configured to control the flow of pressurized carbon dioxide from a source of carbon dioxide through the flow conduit formed by the first end 530 and the second end of the input tube 520 and into the storage container.

FIG. 5B shows a cross-section view through device 500. Device 500 includes lid structure 510 defining a first opening 512 and second opening 514. The second end 522 of input tube 520 is shown traversing at least partially through the first opening 512 defined by lid structure 510. The first end 530 and the second end 522 of input tube 520 form a flow conduit for pressurized carbon dioxide into a storage container, the first end 530 of the input tube 520 having a coupling for attachment to a source of carbon dioxide, the second end 522 of the input tube 520 including at least one aperture 524 having a diameter smaller than an inner diameter of the input tube 520. Also shown is valve 540 positioned between the first end 530 and the second end 522 of input tube 520. In some embodiments, the valve is positioned at or near the first end of the input tube. In some embodiments, the valve is positioned at the first end of the input tube and forms a part of the coupling to the source of pressurized carbon dioxide. Also shown in the cross-section view of FIG. 5B is vent tube 550 sized to pass through and seal within the second opening 514 defined by the lid structure 510. The vent tube 550 includes a first end 552 and a second end 554 forming a flow conduit for gaseous carbon dioxide out of the storage container. The first end 552 of the vent tube 550 is sized to fit within the storage container and to couple with a lower vent tube (not shown).

### Lid Structure

The devices and systems for dry ice production described herein include a lid structure sized for placement over an opening to a storage container. The lid structure is sized to cover the entirety of the opening to the storage container. In some embodiments, the lid structure is sized for placement over an opening to a vacuum insulated storage container. For example, the lid structure can be sized for placement over an opening to a standard 1-4 liter thermos. At least a portion of a surface of the lid structure (e.g., a bottom surface) that is intended to come in contact with the top of the open storage container has a substantially flat surface so as to make good contact with a rim or lip of the storage container. The lid structure forms an attachment site for the input tube and the vent tube and is also intended to retain the dry ice in the storage container as it is being formed. In some embodiments, at least a portion of a bottom surface of the lid structure includes a rubberized surface configured to form a tighter interaction or seal with the rim or lip of the storage container during the dry ice forming/filling process.

The lid structure can be round, square, oval, triangular, or any other polygonal shape with sufficient surface area on at least one side to completely cover an opening to a storage container. In an aspect, the lid structure is disk-shaped. For example, the lid structure can be disk-shaped, having a diameter (e.g., 5-7 inches) sufficient to cover an opening to a storage container and a thickness of about 0.5 to 1.0 inches.

In an aspect, the diameter or width of the lid structure is sufficient to cover the entirety of an opening of a storage container. In an aspect, the diameter or width of the lid structure is about 2 inches to about 10 inches. For example, the diameter or width of the lid structure can be 2 inches, 2.1 inches, 2.2 inches, 2.3 inches, 2.4 inches, 2.5 inches, 2.6 inches, 2.7 inches, 2.8 inches, 2.9 inches, 3 inches, 3.1 inches, 3.2 inches, 3.3 inches, 3.4 inches, 3.5 inches, 3.6 inches, 3.7 inches, 3.8 inches, 3.9 inches, 4 inches, 4.1 inches, 4.2 inches, 4.3 inches, 4.4 inches, 4.5 inches, 4.6 inches, 4.7 inches, 4.8 inches, 4.9 inches, 5 inches, 5.1 inches, 5.2 inches, 5.3 inches, 5.4 inches, 5.5 inches, 5.6 inches, 5.7 inches, 5.8 inches, 5.9 inches, 6 inches, 6.1 inches, 6.2 inches, 6.3 inches, 6.4 inches, 6.5 inches, 6.6 inches, 6.7 inches, 6.8 inches, 6.9 inches, 7 inches, 7.1 inches, 7.2 inches, 7.3 inches, 7.4 inches, 7.5 inches, 7.6 inches, 7.7 inches, 7.8 inches, 7.9 inches, 8 inches, 8.1 inches, 8.2 inches, 8.3 inches, 8.4 inches, 8.5 inches, 8.6 inches, 8.7 inches, 8.8 inches, 8.9 inches, 9 inches, 9.1 inches, 9.2 inches, 9.3 inches, 9.4 inches, 9.5 inches, 9.6 inches, 9.7 inches, 9.8 inches, 9.9 inches, or 10 inches. It is further contemplated that the lid structure may be smaller than 2 inches in diameter or width or larger than 10 inches in diameter or width depending upon the size of the storage container for its intended use.

The lid structure is intended for placement on top of a storage container into which dry ice will be formed. The lid structure has sufficient thickness so as to hold its rigidity while being held in contact with the rim of the storage container. In an aspect, the thickness of the lid structure is about 0.10 inches to about 1 inch. For example, the thickness of the lid structure can be 0.10 inches, 0.13 inches, 0.15 inches, 0.20 inches, 0.25 inches, 0.30 inches, 0.35 inches, 0.40 inches, 0.45 inches, 0.50 inches, 0.55 inches, 0.60 inches, 0.65 inches, 0.70 inches, 0.75 inches, 0.80 inches, 0.85 inches, 0.90 inches, 0.95 inches, or 1 inch. It is further contemplated that the lid structure may be thinner than 0.1 inches or thicker than 1 inch, depending upon at least one of the material from which it is formed and/or the sized of the opening to the storage container.

In some embodiments, the lid structure includes a lower portion sized to fit into the opening of the storage container. In this instance, the first and second openings defined by the lid structure also pass through the lower portion of the lid structure. A non-limiting example of a lid structure including a lower portion sized to fit into the opening of the storage container is shown in FIG. 4. In some embodiments, the lower portion of the lid structure is sized to just fit into the opening of the storage container and can be used to center the lid structure over the storage container. In some embodiments, the lower portion of the lid structure forms a tight fit with the opening of the storage container. In some embodiments, the lower portion of the lid structure forms a loose fit with the opening of the storage container. The lower portion of the lid structure may also provide more closure over the storage container during the dry ice forming/filling process. In an aspect, the lower portion of the lid structure is about 0.5 inches to about 4 inches thick. For example, the lower portion can be 0.5 inches, 1 inch, 1.5 inches, 2 inches, 2.5 inches, 3.0 inches, 3.5 inches, or 4 inches. In some embodiments, the thickness of the lower portion of the lid structure is less than 0.5 inches. In some embodiments, the thickness of the lower portion of the lid structure is greater than 4 inches. The thickness (as well as the diameter or width) of the lower portion of the lid structure will in part be dependent upon the overall internal volume or depth of the storage container.

In some embodiments, the lower portion is formed separately and attached to the lid structure with an adhesive. In some embodiments, the lower portion and the lid structure are machined as a single unit from a slab of material (e.g., a slab of plastic, polymer, or composite material). For example, the lid structure including a lower portion can be machined from a slap of polyethylene material. In some embodiments, the lid structure and the lower portion are formed as a single unit by an injection molding process. In some embodiments, the main lid structure and the lower portion are formed as a single unit by a three-dimensional (3-D) printing process.

In an aspect, the lid structure is formed from a non-thermally conductive material. For example, the lid structure is formed from a material that does not easily conduct the cold associated the formation of dry ice in the storage container. For example, the lid structure can be formed from a material that has sufficient insulation properties to prevent harm to a user. As an example, a user may not have access to adequate hand protection, e.g., insulated gloves, and as such it is important that the lid structure, which the user may be manually holding down on the storage container during dry ice formation and filling, does not rapidly reach dangerously cold temperatures. In an aspect, the lid structure is formed from a material having a low thermal conductivity value. Thermal conductivity is a measure of the heat conduction properties of a material. Heat transfer occurs at a lower rate across materials of low thermal conductivity than across materials of high thermal conductivity. Metals readily conduct heat while plastics do not. For example, polyethylene low density (PEL) has a thermal conductivity of 0.33 W/(m K) while copper has a thermal conductivity of 401 W/(m K). Materials with low thermal conductivity may be used as thermal insulation. In an aspect, the lid structure is formed from polyethylene. Other non-limiting examples of materials with a low thermal conductivity value include acrylonitrile butadiene styrene (ABS), Styrofoam, rubber, polycarbonate, polyisoprene, polypropylene, polystyrene, or nylon. In an aspect, the lid structure with or without a lower portion is cut or machined from a piece (e.g., a slab) of material with a low thermal conductivity value. In an aspect, the lid structure with or without a lower portion is injection molded from a material with a low thermal conductivity value. In an aspect, the lid structure with or without a lower portion is formed from a material with a low thermal conductivity value using a three-dimensional (3-D) printing process.

In an aspect, the lid structure if formed from a plastic or polymer material. Non-limiting examples of plastic or polymer materials include polyester, polyethylene terephthalate, polyethylene, polyvinyl chloride, polyvinylidene chloride, polypropylene, polystyrene, polyamides, nylon, acrylonitrile butadiene styrene, polycarbonate, polyurethane, or combinations thereof. For example, the lid structure can be formed from a form of polyethylene (e.g., high-density polyethylene, linear low-density polyethylene, or low-density polyethylene). Additional non-limiting examples of plastic or polymer materials include maleimide, bismaleimide, melamine formaldehyde, phenolics, polyepoxide, polyetheretherketone, polyetherimide, polylactic acid, polymethyl methacrylate, polyteterfluoroethylene, furan, polysulfone, or urea-formaldehyde.

In some embodiments, the lid structure is formed from a composite material. In an aspect, the lid structure is formed from a composite material made from two or more constituent materials with significantly different physical or chemical properties that when combined form a material with characteristics different from the individual constituent materials. In an aspect, the composite material has a matrix and a reinforcement, which when combined give properties superior to the properties of the individual components. In an aspect, the composite material includes reinforced plastics, e.g., fiber-reinforced plastics. For example, the reinforced plastics or polymers can be reinforced with glass fibers, carbon fibers, and/or cellulose. For example, the composite material can include carbon-fiber-reinforced polymer. For example, the composite material can include glass-reinforced plastic. For example, the composite material can include aramid products. In an aspect, the composite material can include a matrix material, e.g., polyester, vinyl ester, epoxy, phenolic, polyimide, polyamide, polypropylene, and/or polyetheretherketone combined with a reinforcing fiber type. In an aspect, the composite material includes a ceramic composite, e.g., ceramic and metal matrices.

In some embodiments, the lid structure is formed from a plastic or polymer material with a glass transition temperature below 0° C. The glass transition temperature of a plastic or polymer material is a temperature at which the plastic or polymer material experiences a significant change in properties. A plastic or polymer material may become “rubbery” upon heating and “glassy” upon cooling. The glass transition temperature provides an indication as to how brittle a plastic or a polymer material might become in response to cold temperature. For example, a plastic or polymer material with a high glass transition temperature is more likely to become brittle and potentially crack in response to the cold temperatures associated with the dry ice forming process. Non-limiting examples of plastic or polymer materials with a glass transition temperature below 0° C. include high density polyethylene, low density polyethylene, linear low density polyethylene, polycaprolactone, modified polycarbonate, plasticized polyvinyl chloride, polyvinylidene chloride, or polyvinylidene fluoride.

In some embodiments, the lid structure is formed using an injection molding process. For example, the lid structure can be formed by injection molding from polyethylene. Other examples of materials for injection molding include, but are not limited to, acrylonitrile butadiene styrene (ABS), ABS/polycarbonate (ABS/PC), engineered thermoplastic polyurethane ETPU, high density polyethylene (HDPE), light crystal polymer (LCD), low density polyethylene (LDPE), linear low density polyethylene (LLDPE), nylon, polybutylene terephthalate (PBT), polycarbonate (PC), PC/PBT, polyetheretherketone (PEEK), polyetherimide (PEI), thermoplastic polyester resin (PET), co-polyester (PETG), acrylic (PMMA), polypropylene (PP), polyphenylene ether/high impact polystyrene (PPE/PS, polyphenylene sulfide (PPS), polystyrene (PS), polysulfone (PSU), styrene butadiene (SB), thermoplastic elastomer/thermoplastic vulcanizate (TPE/TPV), and/or thermoplastic polyurethane elastomer (TPU).

The lid structure further defines a first opening and a second opening. The first opening is sized to accommodate an input tube and the second opening is sized to accommodate a vent tube. In some embodiments, the diameter or width of the first and the second opening is defined by the outer diameter or width of the corresponding input tube and vent tube. In some embodiments, the outer diameter or width of the input tube and/or the vent tube dictates the diameter or width of the first opening and/or the second opening. In some embodiments, the first and second openings can be cut or machined into the lid structure. In some embodiments, the first and second openings are formed as part of injection molding manufacture or three-dimensional (3-D) printing of the lid structure.

In some embodiments, the lid structure is manually held in place by a user. In some embodiments, the lid structure includes a mechanism that temporarily holds the lid structure in place over the storage container. For example, a mechanism that temporarily holds the lid structure in place over the storage container can include brackets, clamps, screws, bolts, or similar devices. For example, the mechanism can include a structure (e.g., a collar) temporarily placed around the neck of the storage container to which the lid structure can be bracketed, clamped, screwed, or bolted during the dry ice filling process. The mechanism can include the combination of a collar or similar structure and at least one bracket, clamp, screw, bolt, or other holding device. In some embodiments, a portion of a lid structure includes screw threads compatible with threads associated with the opening to the storage container. For example, the lid structure could have threads to allow it to screw on to the storage container in the same way that the storage container's cap or lid is screwed in place.

### Input Tube

The devices and systems described herein for dry ice production include an input tube. The input tube is sized to traverse at least partially through a first opening defined by the lid structure. The input tube has a first end and a second end forming a flow conduit for pressurized carbon dioxide into the storage container. The first end of the input tube has a coupling for attachment to a source of carbon dioxide (e.g., a compressed gas cylinder or refrigerated liquid carbon dioxide tank). The second end of the input tube traverses at least partially through the first opening defined by the lid structure and includes at least one aperture having a diameter that is smaller than the inner diameter of the input tube.

In an aspect, the input tube is formed from a material capable of withstanding operational pressures associated with connecting the device or system to a source of carbon dioxide. In some embodiments, the source of the carbon dioxide is an insulated bulk storage tank of liquid carbon dioxide. For example, the source of liquid carbon dioxide can include a vacuum insulated bulk storage tank with venting which maintains the carbon dioxide in liquid form at a temperature of −25° C. under pressure at 250 psi (approximately 17.5 bar). The operational pressures of the input tube while connected to the vacuum insulated bulk storage tank might be 250-350 psi (approximately 17.5 to 24 bar).

In some embodiments, the source of the carbon dioxide is a high pressure cylinder. For example, the source of carbon dioxide can be a green high pressure cylinder stored at room temperature with no venting. As room temperature increases, the tank temperature increases and the pressure increases. At typical room temperatures of 20° C., the high pressure cylinder is at 900 psi (62 bar). The operational pressures of the input tube while connected to the high pressure room temperature cylinder might be 800-1000 psi (approximately 55 to 69 bar).

Given the potential operational pressures of the system, the input tube is formed from a material with sufficient strength and/or thickness to withstand the operational pressures. In an aspect, the input tube is formed from a material with at least one of a strength or a wall thickness sufficient to withstand operational pressures of up to 1000 psi (pounds per square inch). In an aspect, the input tube is formed from at least one of copper, a copper alloy, or stainless steel. For example, the input tube can include standard Type K, L, M, DWV, or medical gas copper or copper alloy tubing, depending upon the operational pressures. For example, the input tube can be formed from brass. Other non-limiting materials for use in manufacturing the input tube include carbon steel or aluminum alloy.

In an aspect, the input tube is formed from a type of standardized pipe. For example, the input tube can be formed from piping that conforms to the nominal pipe size (NPS) standards. For example, the input tube can be formed from standard threaded piping that conforms to the American National Standard Pipe Thread standard. For example, the input tube can be formed from one or more of standard ⅛ inch, ¼ inch, ⅜ inch, ½ inch, ¾ inch, or 1 inch piping. In an aspect, the input tube can be as large as standard ¾ inch or 1 inch pipe. In an aspect, at least a portion of the input tube comprises standard ¼ inch pipe. In an aspect, at least a portion of the input tube comprises standard ⅛ inch pipe. In an aspect, the input tube is formed from a metric standard pipe (DN, “diametre nominel”). For example, the input tube can be formed from one or more of standard 6 mm, 8 mm, 10 mm, 15 mm, 20 mm, 25 mm, 32 mm, or 40 mm standard pipe. In an aspect, the input tube can be as large as standard 32 or 40 mm pipe.

In some embodiments, the devices and systems described herein further include at least one second first opening defined by the lid structure and at least one second input tube sized to traverse at least partially through the at least one second first opening defined by the lid structure, the at least one second input tube having a first end and a second end forming a flow conduit for pressurized carbon dioxide into the storage container, the first end of the at least one second input tube having a coupling for attachment to a source of carbon dioxide, the second end of the at least one second input tube traversing at least partially through the at least one second first opening defined by the lid structure and including at least one aperture having a diameter smaller than an inner diameter of the at least one second input tube. In an aspect, the lid structure defines from one to twelve first openings sized to accept input tubes. For example, the lid structure defines one, two, three, four, five, six, seven, eight, nine, ten, eleven, or twelve first openings. In some embodiments, the lid structure defines more than twelve first openings. In an aspect, the input tube and the at least one second input tube are part of an octopus connection between the source of pressurized carbon dioxide and the lid structure. For example, the input tube and the at least one second input tube can form two or more input paths for carbon dioxide into the storage container from the source of pressurized carbon dioxide. By varying the number of inputs, the speed of filling the storage container can be modulated, improving the efficiency of filling, especially for large storage containers.

The first end of the input tube includes a coupling for attachment to a source of carbon dioxide. In an aspect, the coupling is configured to attach the input tube directly to a regulator associated with the source of carbon dioxide. For example, the coupling can include a fitting configured to attach to an outlet fitting of a regulator. In an aspect, the coupling is configured to connect the input tube indirectly to the source of pressurized carbon dioxide. For example, the coupling can include a fitting configured to connect the input tube to a flexible metal-reinforced tubing attached to a source of pressurized carbon dioxide, e.g., to a gas cylinder or insulated tank. Couplings, e.g., fittings, appropriate for use with copper, copper alloy, or stainless steel piping or tubing are available from commercial sources (from, e.g., McMaster-Carr, Santa Fe Springs, Calif.). For example, the coupling can include a compression type tube fitting formed from brass or stainless steel. For example, the coupling can include a threaded fitting. For example, the coupling can include a fitting screwed, glued, or welded to the first end of the input tube.

The second end of the input tube includes at least one aperture having a diameter smaller than the inner diameter of the input tube. In general, the input tube diameter is preferably larger than the aperture diameter so as to prevent formation of dry ice in the input tube prior to reaching the storage container. In some embodiments, the at least one aperture at the second end of the input tube comprises a single aperture at the extreme end of the second end of the input tube. For example, the aperture can be machined (e.g., punched or drilled) into an otherwise closed second end of the input tube. In some embodiments, the at least aperture at the second end of the input tube comprises an array of two or more apertures at the extreme end of the second end of the input tube. For example, an array of apertures can be machined into an otherwise closed second end of the input tube. For example, the array of apertures can range from one aperture to twenty apertures. For example, the array of apertures can be 1 aperture, 2 apertures, 3 apertures, 4 apertures, 5 apertures, 6 apertures, 7 apertures, 8 apertures, 9 apertures, 10 apertures, 11 apertures, 12 apertures, 13 apertures, 14 apertures, 15 apertures, 16 apertures, 17 apertures, 18 apertures, 19 apertures, or 20 apertures. In some embodiments, the array of apertures includes more than 20 apertures. In some embodiments, the at least one aperture at the second end of the input tube comprises at least one aperture defined by a wall of the input tube at the second end of the input tube. For example, the input tube can include one or more apertures (openings) located on the wall of the input tube at or near the second end of the input tube. For example, the input tube can include an array of openings on the wall of the input tube at or near the second end of the input tube. In some embodiments, the second end of the input tube includes at least one aperture at the extreme end of the input tube and at least one aperture defined by a wall of the input tube at the second end of the input tube. For example, the input tube can include a series of openings at the end and on the walls of the input tube at the second end of the input tube.

In some embodiments, the at least one aperture at the second end of the input tube is associated with a fitting attachable to the second end of the input tube. For example, the aperture can be associated with a fitting configured to screw on to the second end of the input tube. For example, fittings with orifices (i.e., apertures) ranging in diameter from 0.01 inch to 0.125 inch are available from commercial sources (from, e.g., McMaster-Carr, Santa Fe Springs, Calif.).

In an aspect, the at least one aperture is circular. However, other shapes are contemplated, non-limiting examples of which include triangular, square, rectangular, polygonal, or trapezoidal. In an aspect, the at least one aperture forms at least one slit at the second end of the inner tube.

In an aspect, the size of the at least one aperture will dictate how quickly the dry ice is formed. In some embodiments, the diameter of the at least one aperture at the second end of the input tube is sized proportional to a filling rate. For example, to create dry ice faster, the aperture is made larger. However, enlarging the size of the aperture may also increase the amount of gaseous carbon dioxide that needs to be vented and as such the vent tube may need to be enlarged accordingly to vent the extra gas volume without over-pressurizing the storage container. In some embodiments, the input tube may be supplied with a series of fittings attachable to the second end of the input tube and include varied aperture sizes to control speed of dry ice formation in the storage container. In general, the aperture size is at least less than the inner diameter of the input tube and at most 0.25 inches. In an aspect, the aperture is about 0.001 inches to about 0.25 inches in diameter. For example, the aperture can be 0.001 inches, 0.002 inches, 0.003 inches, 0.004 inches, 0.005 inches, 0.006 inches, 0.007 inches, 0.008 inches, 0.009 inches, 0.010 inches, 0.011 inches, 0.012 inches, 0.013 inches, 0.014 inches, 0.015 inches, 0.016 inches, 0.017 inches, 0.018 inches, 0.019 inches, 0.02 inches, 0.022 inches, 0.024 inches, 0.026 inches, 0.028 inches, 0.03 inches, 0.032 inches, 0.034 inches, 0.036 inches, 0.038 inches, 0.04 inches, 0.042 inches, 0.044 inches, 0.046 inches, 0.048 inches, 0.05 inches, 0.052 inches, 0.054 inches, 0.056 inches, 0.058 inches, 0.06 inches, 0.062 inches, 0.064 inches, 0.066 inches, 0.068 inches, 0.07 inches, 0.072 inches, 0.074 inches, 0.076 inches, 0.078 inches, 0.08 inches, 0.082 inches, 0.084 inches, 0.086 inches, 0.088 inches, 0.09 inches, 0.092 inches, 0.094 inches, 0.096 inches, 0.098 inches, 0.1 inches, 0.11 inches, 0.12 inches, 0.13 inches, 0.14 inches, 0.15 inches, 0.16 inches, 0.17 inches, 0.18 inches, 0.19 inches, 0.2 inches, 0.21 inches, 0.22 inches, 0.23 inches, 0.24 inches or 0.25 inches in diameter. It is also contemplated that in some embodiments, the aperture is smaller than 0.001 inches or larger than 0.25 inches in diameter. In some embodiments, the at least one aperture at the second end of the input tube and having a diameter smaller than the inner diameter of the input tube is about 0.062 inches in diameter.

In an aspect, the diameter of the at least one aperture at the second end of the input tube is sized inversely proportional to pressure in the input tube. For example, under conditions where the operational pressures are about 200-300 psi, the aperture may be sized larger than under conditions where the operational pressures are about 800-1000 psi. As the operational pressures increase, the rate of pressurized carbon dioxide entering the storage container increases, putting greater pressure on other components of the device or system. As such, a user may opt for an aperture of smaller diameter to limit the rate of flow into the storage container. In some embodiments, the input tube may be supplied with a series of fittings attachable to the second end of the input tube varied aperture sizes for use with various sources of pressurized carbon dioxide.

In an aspect, the tolerances associated with formation of the first opening in the lid structure and the choice of the tubing for the input tube keeps the parts from leaking dry ice between them during the dry ice forming process. In an aspect, fittings may be used to keep the input tube connected to the lid structure. For example, a small diameter tube with larger brass fittings on either end could be used to secure the tubing in the lid structure. In an aspect, the seal between the input tube and the lid structure may be formed with the use of Teflon tape or similar material wrapped around a portion of the input tube that traverses the first opening in the lid structure. In an aspect, the input tube and the lid structure are sealed together with a sealant. In an aspect, the input tube and the lid structure are press fit to form a seal. In an aspect, the input tube and the lid structure are glued to form a seal.

In some embodiments, the input tube is at least partially covered with an insulation material. For example, a portion of the input tube that might come in contact with a user's hand can be covered with an insulation material. For example, at least a portion of the input tube can be wrapped with an insulation material. For example, at least a portion of the input tube can be covered with a piece of pipe insulation formed from polyethylene, rubber, or foam (e.g., Styrofoam). In some embodiments, the insulation material comprises a rubberized plastic coating. For example, at least a portion of the input tube can be coated with a commercially available liquid rubber coating (e.g., FLEX SEAL Liquid from Swift Response, LLC, Weston, Fla.).

### Vent

The devices and systems described herein for dry ice production include a vent tube. In an aspect, the cross-sectional shape of the vent tube is circular. However, other cross-sectional shapes are contemplated, non-limiting examples of which include oval, square, triangular, polygonal, rectangular, or other cross-sectional shapes.

The vent tube can be formed from any of a number of materials. In general, the material used to form the vent tube is cold tolerant in that it remains relatively durable under operational temperature conditions which could be as low as −80° C. In an aspect, the vent tube is formed from a metal or metal alloy. In an aspect, the vent tube is formed from at least one of copper, copper alloy, stainless steel, or aluminum. Other non-limiting metals or metal alloys include carbon steel alloy. In an aspect, the vent tube is formed from a plastic or polymer material. For example, the vent tube can be formed from polyethylene. In an aspect, the vent tube is formed from a composite material. For example, the vent tube may be formed from carbon or glass fiber reinforced plastic. In some embodiments, the vent tube is formed from a plastic or polymer material with a glass transition temperature below 0° C. For example, the vent tube can be formed from high density polyethylene, low density polyethylene, linear low density polyethylene, polycaprolactone, modified polycarbonate, plasticized polyvinyl chloride, polyvinylidene chloride, or polyvinylidene fluoride.

Ideally, the vent tube is light weight, durable (e.g., not brittle) under the cold temperature conditions associated with forming dry ice, and has low thermal conductivity. In some embodiments, the vent tube is formed from any of the plastic/polymer materials described above for forming the lid structure. In some embodiments, the vent tube is formed from any of the composite materials described above for forming the lid structure. In some embodiments, the lid structure and the vent tube are formed as a single manufactured unit. For example, the lid structure and the vent tube can be formed as a single manufactured unit using an injection molding manufacturing process. For example, the lid structure and the vent tube can be formed as a single manufactured unit using a three-dimensional (3-D) printing process. For example, the lid structure and the vent tube can be formed as a single manufactured unit from a plastic or polymer material. For example, the lid structure and the vent tube can be formed as a single manufactured unit from a composite material. For example, the lid structure and the vent tube can be formed as a single manufactured unit from a material having a low thermal conductivity value. For example, the lid structure and the vent tube can be formed as a single manufactured unit from a plastic or polymer material with a glass transition temperature below 0° C. For example, the lid structure and the vent tube can be formed as a single manufactured unit from polyethylene. For example, the lid structure and the vent tube can be formed as a single manufactured unit from carbon fiber or fiber glass reinforced plastic.

In some embodiments, the vent tube of the devices and systems described herein for dry ice production includes a feature to vent the escaping gaseous carbon dioxide away from a user. For example, the user may be holding the lid structure in place over the storage container while controlling an on/off valve. Exposure to gaseous carbon dioxide can cause hypercapnia (abnormally elevated carbon dioxide levels in the blood), especially in confined locations, causing headache, confusion, and lethargy. Features may also be designed to deflect escaping flakes of dry ice away from a user.

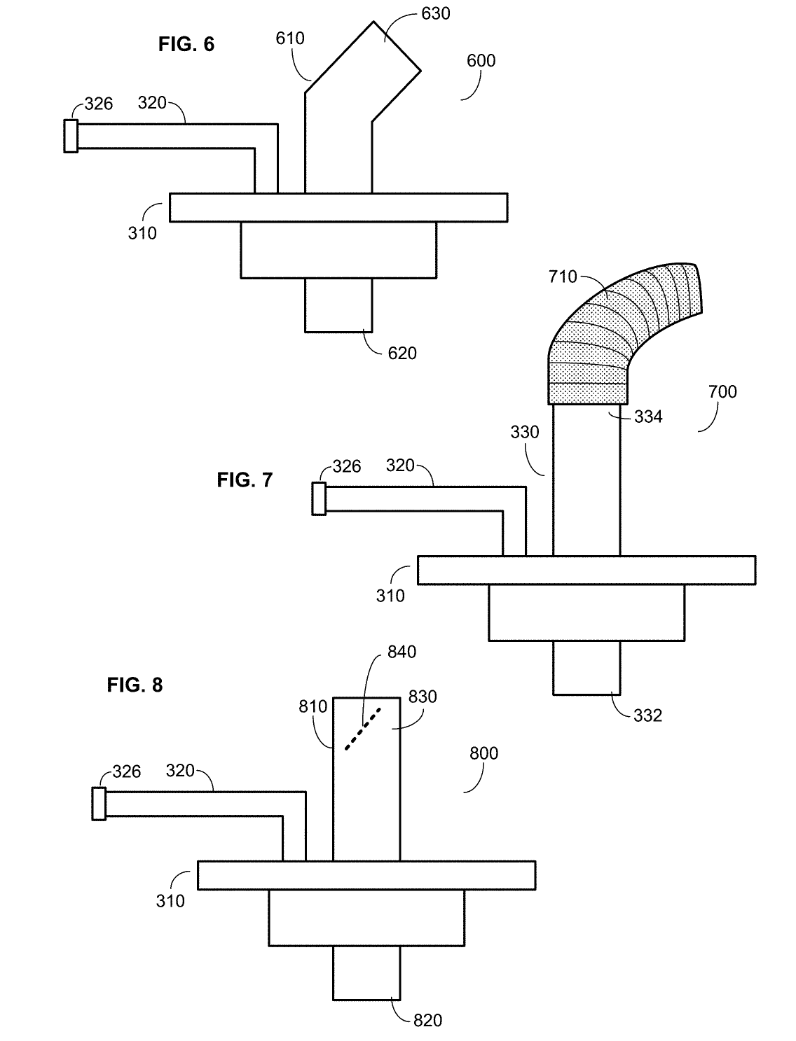

FIGS. 6-8 illustrate non-limiting embodiments of features designed to vent the escaping gaseous carbon dioxide away from the user. In some embodiments, the second end of the vent tube is bent at an angle from vertical away from the input tube to deflect the gaseous carbon dioxide. A non-limiting example is shown in FIG. 6. Device 600 includes lid structure 310 and input tube 320 including coupling 326. Device 600 further includes vent tube 610 which has a first end 620 and a second end 630 forming a flow conduit for gaseous carbon dioxide through the lid structure 310. The second end 630 of vent tube 610 is shown bent at an angle from vertical away from input tube 320. In some embodiments, the vent tube is bent away from the input tube where a user is intended to control an on/off valve controlling flow of pressurized carbon dioxide from a source of carbon dioxide. The bend in the vent tube vents gaseous carbon dioxide and any escaping flakes of dry ice away from the user and is intended as a safety measure. In an aspect, the vent tube is bent at a 45 degree angle from vertical away from the input tube. In an aspect, the vent tube is bent at about a 15 degree angle to about a 90 degree angle from vertical away from the input tube. For example, the vent tube can be bent at a 15 degree angle, a 20 degree angle, a 25 degree angle, a 30 degree angle, a 35 degree angle, a 40 degree angle, a 45 degree angle, a 50 degree angle, a 55 degree angle, a 60 degree angle, a 65 degree angle, a 70 degree angle, a 75 degree angle, a 80 degree angle, a 85 degree angle, or a 90 degree angle from vertical away from the input tube. In some embodiments, the vent tube is bent at less than a 15 degree angle from vertical away from the input tube. In some embodiments, the vent tube is bent at more than a 90 degree angle from vertical away from the input tube.

In some embodiments, the second end of the vent tube includes an attachment site for a vent sock or hose. A non-limiting example is shown in FIG. 7. Device 700 includes lid structure 310 and input tube 320 including coupling 326. Device 700 further includes vent tube 330 including a first end 332 and a second end 334 forming a flow conduit for gaseous carbon dioxide through lid structure 310. Also shown is vent sock or hose 710 attached to the second end 334 of vent tube 330. Vent tube 330 can include an attachment site for a long sock or hose that allows expelled gaseous carbon dioxide to be vented further from the user (e.g., out a window or into an unoccupied room). The attachment site at the second end of the vent tube can include at least one of hooks, snaps, or clamps for attaching a vent sock or hose. The attachment site at the second end of the vent tube can include threads for screwing a vent sock or hose to the second end of the vent tube. The attachment site at the second end of the vent tube can include a deformation (e.g., a ridge or a notch) on the outer surface of the vent tube for use with a compression device (e.g., a rubber band) to hold a vent sock or hose in place.

In some embodiments, the second end of the vent tube includes at least one deflector positioned to deflect the gaseous carbon dioxide. For example, the at least one deflector can include a plate or other attachment positioned at or near the second end of the vent tube to deflect, bend, deviate, or redirect the venting gaseous carbon dioxide away from a user. In an aspect, the at least one deflector is moveable so as to control the direction of the venting gaseous carbon dioxide. For example, the at least one deflector can include a moveable plate or other attachment that can be adjusted to controllably deflect, bend, or deviate the venting gaseous carbon dioxide. In some embodiments, the second end of the vent tube includes at least one internal deflector positioned in the flow conduit of the vent tube to deflect the gaseous carbon dioxide. A non-limiting example is shown in FIG. 8. Device 800 includes lid structure 310 and input tube 320 including coupling 326. Device 800 further includes vent tube 810 including a first end 820 and a second end 830 forming a flow conduit for gaseous carbon dioxide through lid structure 310. Also shown in FIG. 8 is deflector 840 (dotted line) positioned at the second end 830 of vent tube 810. Deflector 840 is sized and positioned to deflect, bend, deviate, or redirect escaping gaseous carbon dioxide away from a user. In an aspect, deflector 840 includes at least one plate positioned at an angle within the vent tube to deflect, bend, deviate, or redirect the venting gaseous carbon dioxide. In an aspect, deflector 840 is moveable so as to control the direction of the venting gaseous carbon dioxide.

In some embodiments, a device for dry ice production further includes a lower vent tube sized to extend within an interior portion of the storage container, the lower vent tube having an open first end sized to couple to the first end of the vent tube, a wall of the lower vent tube defining a plurality of openings sized to allow passage of the gaseous carbon dioxide from the storage container, through the lower vent tube, and out the vent tube.

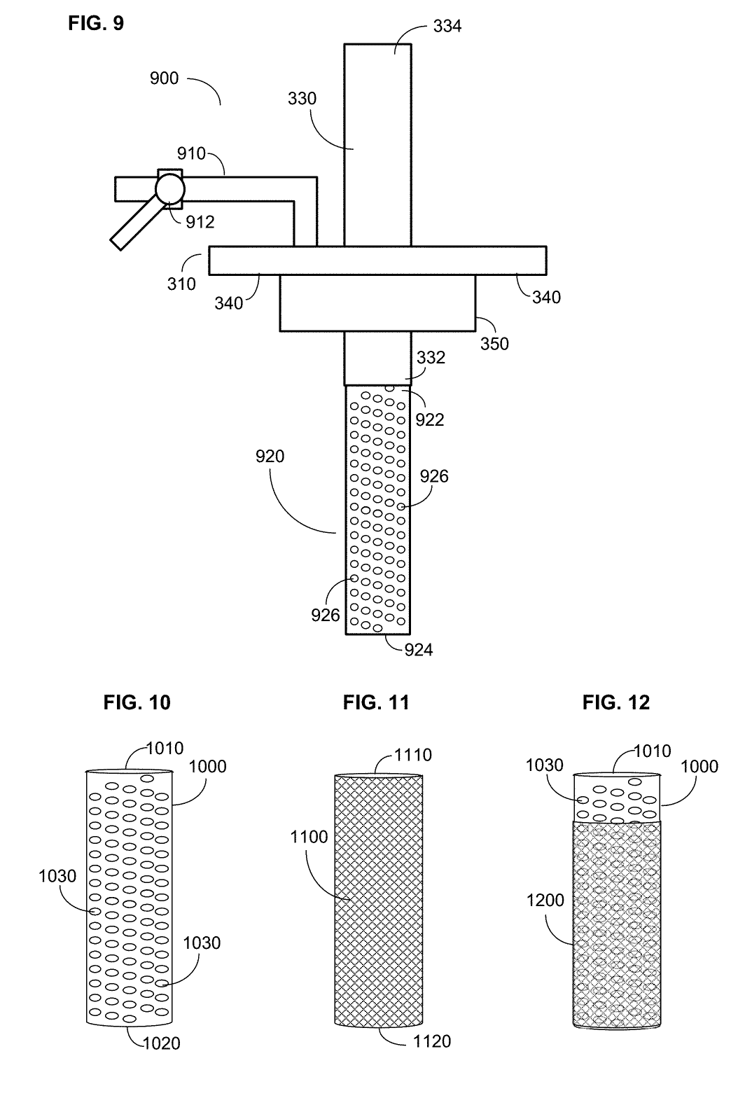

FIG. 9 illustrates further aspects of a device for dry ice production such as shown in FIG. 3 and including a lower vent tube. FIG. 9 shows device 900 including lid structure 310 sized to cover an opening to a storage container and including a first opening and a second opening. Lid structure 310 includes bottom surface 340 for making contact with a rim or lip of the storage container and lower portion 350 configured to fit into the opening of the storage container. Device 900 further includes input tube 910 including valve 912 and vent tube 330. Vent tube 330 includes a first end 332 and a second end 334 forming a flow conduit for gaseous carbon dioxide out of the storage container. The first end 332 of the vent tube 330 is configured to fit within the storage container and sized to couple with a lower vent tube 920. In an aspect lower vent tube 920 is sized to extend within an interior portion of the storage container, the lower vent tube 920 having an open first end 922 sized to couple to the first end 332 of the vent tube 330 and a second end 924. A wall of the lower vent tube 920 defines a plurality of openings 926 sized to allow passage of gaseous carbon dioxide from the storage container, through the lower vent tube 920, and out the vent tube 330.

### Lower Vent Tube

FIGS. 10-12 illustrate further aspects of a lower vent tube such as illustrated in FIG. 9. FIG. 10 shows lower vent tube 1000 having an open first end 1010 sized to couple to the first end of a vent tube and a second end 1020. In some embodiment, the second end 1020 of lower vent tube 1000 is closed to form a storage tube. A wall of the lower vent tube 1000 defines a plurality of openings 1030 sized to allow passage of the gaseous carbon dioxide from the storage container, through the lower vent tube 1000, and out an attached vent tube.

The first end of the lower vent tube is open and sized to couple to the first end of a vent tube. In some embodiments, the second end of the lower vent tube is open. In some embodiments, the second end of the lower vent tube is closed. For example, the second end of the lower vent tube can include a flat or tapered base. The side walls of the lower vent tube define a plurality of openings. For example, the lower vent tube can include a metal tube sized to couple with the vent tube and having a number of holes or perforations in the wall of the tube. In an aspect, the lower vent tube is formed from a metal or metal alloy. For example, the lower vent tube can be formed from stainless steel. Other non-limiting examples of metals or metal alloys for this purpose include copper and copper alloys, carbon steel, bronze, brass, nickel, aluminum, or titanium.

In an aspect, the lower vent tube is formed from a plastic or polymer material. For example, the lower vent tube can be formed from polyethylene tubing with a number of holes or perforations in the wall of the tube and sized to couple with the vent tube at the other end. In an aspect, the lower vent tube is formed from a composite material. For example, the lower vent tube can be formed from carbon fiber or fiberglass reinforced plastic. The plastic, polymer, or composite is ideally a material that remains durable under the extreme temperatures associated with the storage of dry ice. In an aspect, the lower vent tube is formed from a plastic or polymer material with a glass transition temperature of less than 0° C.

In some embodiments, the tube or pipe forming the lower vent tube is machined to produce the plurality of openings. In some embodiments, the tube or pipe forming the lower vent tube is formed from a sheet of perforated material, e.g., stainless steel. In some embodiments, the tube or pipe forming the lower vent tube is injection molded or cast and the plurality of openings are formed during the molding or casting process. In an aspect, the tube or pipe is purchased with pre-existing openings. For example, the lower vent tube can be formed from a perforated stainless steel pipe or tube available from commercial sources (e.g., from, Perforated Tubes, Inc., Ada, Mich.).

In some embodiments, the lower vent tube is formed from a porous or mesh material having a plurality of openings sized to allow passage of the gaseous carbon dioxide from the storage container, through the lower vent tube, and out the vent tube. A non-limiting example is shown in FIG. 11. Lower vent tube 1100 is formed from a porous or mesh material, e.g., a sheet of porous or mesh material. For example, the lower vent tube can be formed from a sheet or tube of metal or plastic mesh. For example, the lower vent tube can be formed from a sheet or tube of stiff porous woven fabric. For example, the lower vent tube can be formed from a porous plastic tube (commercially available from, e.g., GenPore, Reading, Pa.). In an aspect, the lower vent tube is formed from nylon and machined to include the plurality of openings. Lower vent tube 1100 includes a first end 1110 sized to couple with the first end of a vent tube. In some embodiments, lower vent tube 1100 includes an open second end 1120. In some embodiments, lower vent tube 1100 includes a closed second end 1120.

The first end of the lower vent tube is sized to couple to the first end of the vent tube. In some embodiments, the first end of the lower vent tube is sized to couple to the first end of the vent tube through a male/female coupling. For example, the outer diameter of the first end of the lower vent tube can be sized to fit snugly into the inner diameter of the first end of the vent tube. In an aspect, the first end of the lower vent tube slides into the first end of the vent tube. In an aspect, the first end of the lower vent tube screws into the first end of the vent tube. The coupling is reversible to allow separation of the vent/lid structure from the lower vent tube after sufficient dry ice has been produced.

In some embodiments, the lower vent tube is configured to fit entirely within the storage container. In some embodiments, the length of the lower vent tube is dependent upon the length of the storage container for which it will be used. For example, the length of the lower vent tube can be about 11 inches to fit entirely within a 2 liter vacuum insulated storage container having an outer length of 14-15 inches. In some embodiments, the length of the lower vent tube is independent of the length of the storage container, as long as the lower vent tube fits entirely within the storage container. In an aspect, the length of the lower vent tube is about 2 inches to about 15 inches. For example, the length of the lower vent tube is 2 inches, 2.5 inches, 3 inches, 3.5 inches, 4 inches, 4.5 inches, 5 inches, 5.5 inches, 6 inches, 6.5 inches, 7 inches, 7.5 inches, 8 inches, 8.5 inches, 9 inches, 9.5 inches, 10 inches, 10.5 inches, 11 inches, 11.5 inches, 12 inches, 12.5 inches, 13 inches, 13.5 inches, 14 inches, 14.5 inches, or 15 inches. It is contemplated that the lower vent tube can be shorter than 2 inches or longer than 15 inches, depending upon the size of the storage container and the purpose for which it is used. In some embodiments, the lower vent tube is formed from two or more telescoping sections. For example, the lower vent tube can be formed from two or more telescoping sections to allow for adjustment of the length of the lower vent tube to accommodate a variety of sized storage containers.

In some embodiments, the lower vent tube is at least partially covered with a porous material, wherein the porous material defines openings sized to at least partially prevent passage of solid carbon dioxide flakes into the interior portion of the lower vent tube and the vent tube. For example, the lower vent tube can be at least partially covered with a porous fabric or other woven material. In some embodiments, the lower vent tube is at least partially covered with a mesh material, wherein the mesh material defines openings sized to at least partially prevent passage of solid carbon dioxide flakes into the interior portion of the lower vent tube and the vent tube. FIG. 12 illustrates a non-limiting example. Lower vent tube 1000 includes a wall defining a plurality of openings 1030 and is at least partially covered with a porous or mesh material 1200. In this non-limiting example, the porous or mesh material 1200 does not cover a portion of the lower vent tube 1000 near the first end 1010 as this portion of the lower vent tube 1000 is configured to couple with a first end of a vent tube. However, in other embodiments, the porous or mesh material covers the entirety of the lower vent tube.

In an aspect, the devices and systems for dry ice production described herein include a porous or mesh material covering at least a portion of the lower vent tube. For example, the porous or mesh material can be configured to cover those portions of the vertical walls of the lower vent tube that are otherwise not involved in coupling to the vent tube. For example, an upper length of the lower vent tube (e.g., 0.5 to 1 inch of length) may be left uncovered by the porous or mesh material (as exemplified in FIG. 12). In an aspect, the porous or mesh material covers the entire surface of the lower vent tube. The porous or mesh material can include a sheet of porous or mesh material formed around the lower vent tube. The porous or mesh material can include a tube of porous or mesh material configured to fit over the structure of the lower vent tube.

In an aspect, the mesh material is formed from a metal or metal alloy. In an aspect, the mesh material includes a metal mesh or wired cloth formed from a metal or metal alloy. The metal mesh can be woven, knitted, welded, expanded, photo-chemically etched, or electroformed. In an aspect, the metal mesh is formed from one or more of stainless steel, plain steel, galvanized steel, copper, brass, bronze, nickel, or aluminum.

In an aspect, the mesh material is formed from a plastic or polymer material. In an aspect, the mesh material includes a plastic or polymer mesh formed from at least one of polypropylene, polyethylene, polyester, polybutylene terephthalate, nylon, polyvinyl chloride, or polytetrafluoroethylene. The plastic mesh can be extruded, oriented, expanded, woven, or tubular. In an aspect, the mesh material includes a fiberglass mesh. The fiberglass mesh can be woven. In an aspect, the mesh material includes molded plastic mesh formed from polyethylene or polypropylene. Mesh material formed from nylon, polyester, polypropylene, or PEEK, with opening sizes ranging from 0.0011 inches to 0.012 inches are available from commercial sources (from, e.g., McMaster-Carr, Santa Fe Springs, Calif.).

In an aspect, the mesh material is formed from a sheet of standard mesh material (e.g., standard US or Tyler mesh). In an aspect, the mesh material is formed from a sheet of tensile bolting cloth. In an aspect, the mesh material is formed from a sheet of mill grade mesh. In an aspect, the mesh material is formed from market grade mesh. The mesh material includes a mesh size. In some embodiments, the mesh size corresponds to a sieve size or opening size. In an aspect, the opening size of the mesh ranges from about 0.0005 to about 0.055 inches. For example, the nominal opening size can be 0.0005 inches, 0.0006 inches, 0.0007 inches, 0.0008 inches, 0.0009 inches, 0.0010 inches, 0.0011 inches, 0.0012 inches, 0.0015 inches, 0.0017 inches, 0.0019 inches, 0.0021 inches, 0.0023 inches, 0.0024 inches, 0.0029 inches, 0.0035 inches, 0.0038 inches, 0.0041 inches, 0.0042 inches, 0.0043 inches, 0.0046 inches, 0.0049 inches, 0.0055 inches, 0.0059 inches, 0.0070 inches, 0.0083 inches, 0.0098 inches, 0.0117 inches, 0.0139 inches, 0.0165 inches, 0.0197 inches, 0.0232 inches, 0.0278 inches, 0.0331 inches, 0.0394 inches, 0.0469 inches, or 0.0555 inches. Ideally, the nominal opening is large enough to allow gas to pass through the mesh material and into the lower vent tube, but small enough to prevent flakes of formed solid carbon dioxide or dry ice passing though the mesh material and into the lower vent tube. In an aspect, the mesh material has an opening size of 0.010 square inches.

In an aspect, the mesh material can be formed from a perforated sheet. In an aspect, the perforated sheet is formed from at least one of stainless steel, steel, aluminum, brass, or plastic. For example, the mesh material can include a stainless steel perforated sheet with hole diameters of about 0.006 inches (commercially available from, e.g., McMaster-Carr, Santa Fe Springs, Calif.).

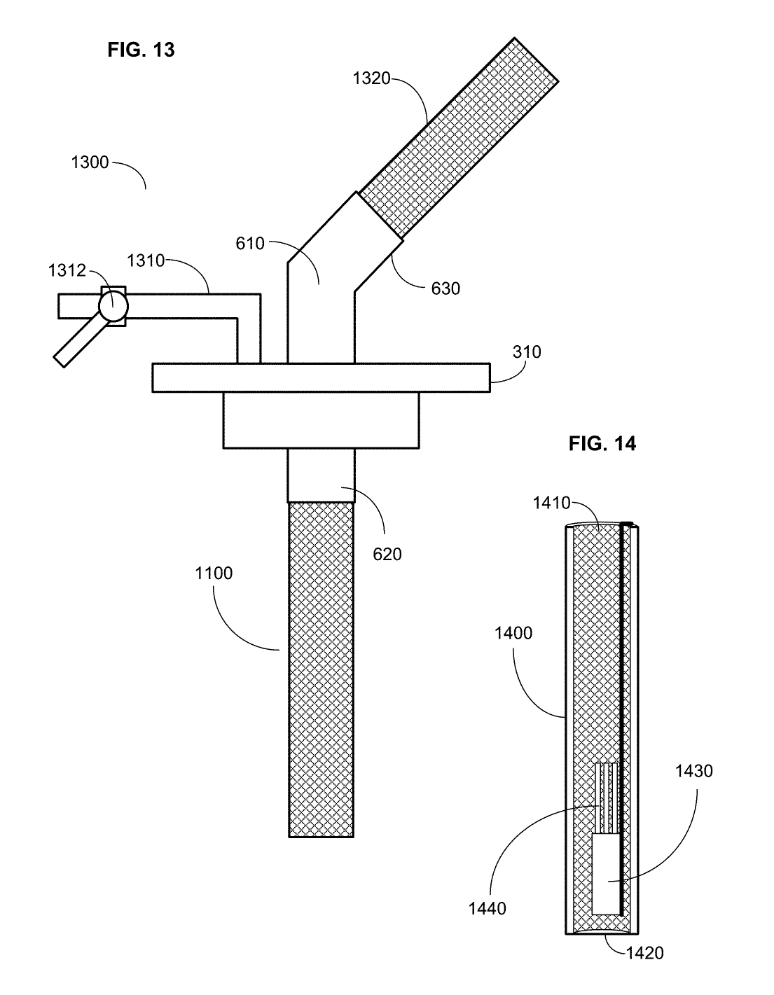

FIG. 13 illustrates further aspects of a device for dry ice formation such as shown in FIG. 6. FIG. 13 shows device 1300 including lid structure 310, input tube 1310, and vent tube 610. Input tube 1310 provides a flow conduit for pressurized carbon dioxide into a storage container and includes a valve 1312 with a spring return handle. Vent tube 610 provides a flow conduit for gaseous carbon dioxide out of the storage container. Vent tube 610 is coupled at a first end 620 to lower vent tube 1100 including a plurality of openings. The second end 630 of vent tube 610 is bent at an angle from vertical away from input tube 1310. The second end 630 of vent tube 610 further includes a vent tube extender 1320. The vent tube extender 1320 is configured to expel the vented gaseous carbon dioxide farther away from a user as the storage container is filled with dry ice. In some embodiments, the vent tube extender 1320 comprises a second lower vent tube coupled to the second end 630 of the vent tube 610. In some embodiments, the vent tube extender 1320 includes a long hose or sock that allows expelled gaseous carbon dioxide to be vented to an even further distance from the user. For example, the vent tube extender can include a long hose or sock that allows the gaseous carbon dioxide to be vented out a window or into an unoccupied room.

In some embodiments, the device for dry ice production is packaged and shipped with at least one attachable lower vent tube. In some embodiments, the device for dry ice production is packaged and shipped with at least two attachable lower vent tubes. For example, the device for dry ice production can be packaged and shipped with at least one lower vent tube for attachment to the first end of the vent tube and at least one second lower vent tube for attachment to the second end of the vent tube to act as an extender.

In some embodiments, the lower vent tube comprises a storage tube sized to fit entirely within the storage container and to hold at least one removable sample holder, the storage tube having an open first end sized to couple to the first end of the vent tube and a closed second end, a wall of the storage tube defining a plurality of openings sized to allow passage of the gaseous carbon dioxide from the storage container, through the storage tube, and out the vent tube.

FIG. 14 illustrates a cross-section view through non-limiting example of a lower vent tube that is a storage tube. Storage tube 1400 includes a first end 1410 which is open and sized to couple to the first end of a vent tube. Storage tube 1400 further includes a second end 1420 that is closed to form the storage tube. Storage tube 1400 is sized to hold at least one removable sample holder 1430. The at least one removable sample holder 1430 is sized to hold at least one sample straw or vial 1440. In an aspect, the storage tube is configured to store temperature sensitive materials (e.g., semen straws or vaccine vials/ampules) in the dry ice formed in the storage container for short term storage (e.g., storage time required to transport semen straws from a central location to an outlying location to perform artificial inseminations).

The storage tube is sized to fit entirely within a storage container. In an aspect, the outside diameter of the storage tube is proportional to the inside diameter or width of the storage container. In an aspect, the outside diameter of the storage tube is at most half of the inside diameter or width of the storage container. The proportionality of the storage tube relative to the intended storage container is dependent upon the size of the storage container, the amount of dry ice required to keep the samples sufficiently cold over a certain time frame, and the number of intended samples for storage.

The storage tube is sized to hold at least one removable sample holder. For example, the length of the storage tube is sufficient to hold a removable sample holder. In an aspect, the at least one removable sample holder is configured to hold straws. For example, the at least one removable sample holder can be configured to hold straws of bull semen. In an aspect, the at least one removable sample holder includes a straw holder. In an aspect, the at least one removable sample holder is configured to hold vials or ampoules. For example, the at least one removable sample hold can be configured to hold 1.2 ml vials. In an aspect, the removable sample holder includes a vial holder. In an aspect, the storage tube is sized to hold at least one sample cane. For example, the storage tube can be sized to hold at least one commercially available sample cane commonly used for cryogenic storage of cells and tissues (290-300 mm, 11.4-11.8 inches). In an aspect, the samples are stored at the extreme end of the removable sample holder so that it takes longer for the loss of dry ice due to sublimation to reach the samples.

Described herein are aspects of a system for dry ice production including a lid structure sized for placement over an opening to a storage container, the lid structure defining a first opening and a second opening; an input tube sized to traverse at least partially through the first opening defined by the lid structure, the input tube having a first end and a second end forming a flow conduit for pressurized carbon dioxide into the storage container, the first end of the input tube having a coupling for attachment to a source of carbon dioxide, the second end of the input tube traversing at least partially through the first opening defined by the lid structure and including at least one aperture having a diameter smaller than an inner diameter of the input tube; a vent tube sized to pass through and seal within the second opening defined by the lid structure, the vent tube having a first end and a second end forming a flow conduit for gaseous carbon dioxide, the first end of the vent tube sized to fit into the storage container; a lower vent tube sized to extend into an interior portion of the storage container, the lower vent tube having an open first end sized to couple to the first end of the vent tube, a wall of the lower vent tube defining a plurality of openings sized to allow passage of the gaseous carbon dioxide from the storage container, through the lower vent tube, and out the vent tube.

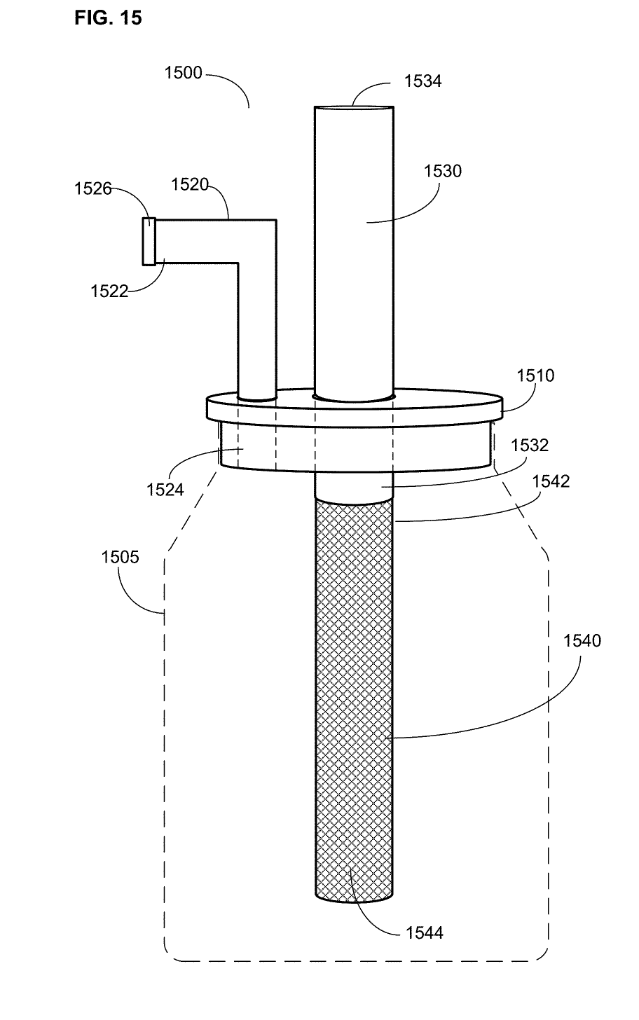

FIG. 15 illustrates aspects of a system for dry ice production. FIG. 15 shows system 1500 sitting on top of storage container 1505 (the outline of which is shown as a dashed line). System 1500 includes lid structure 1510 sized for placement over an opening to storage container 1505 and defining a first opening and a second opening. In an aspect, the lid structure 1510 is disk-shaped. In an aspect, the lid structure 1510 is formed from a material having a low thermal conductivity value. In an aspect, the lid structure 1510 is formed from a plastic or polymer material. In an aspect, the lid structure 1510 is formed from a composite material. In an aspect, the lid structure 1510 is formed from a plastic or polymer material with a glass transition temperature below 0° C. In an aspect, the lid structure 1510 is formed from polyethylene. In an aspect, the lid structure 1510 is sized for placement over an opening to a vacuum insulated storage container. In an aspect, the lid structure 1510 includes a portion sized for fitting into the opening of the storage container. Other non-limiting aspects of a lid structure for use in devices and systems for dry ice production have been described above herein.

System 1500 further includes input tube 1520 sized to traverse at least partially through the first opening defined by the lid structure 1510. The input tube 1520 has a first end 1522 and a second end 1524 forming a flow conduit for pressurized carbon dioxide into the storage container 1505. The first end 1522 of the input tube 1520 further includes a coupling 1526 for attachment to a source of carbon dioxide. In an aspect, the input tube 1520 is formed from a material with at least one of a strength or a wall thickness sufficient to withstand operational pressures of up to 1000 psi. In an aspect, the input tube 1520 is formed from at least one of copper, a copper alloy, or stainless steel. Other non-limiting materials for use in manufacturing the input tube include carbon steel, aluminum alloy, or other metal alloys. In an aspect, the input tube is formed from one or more of standard ⅛ inch, ¼ inch, ⅜ inch, ½ inch, ¾ inch, or 1 inch piping. In an aspect, the input tube can be as large as standard ¾ inch or 1 inch pipe. In an aspect, at least a portion of the input tube comprises standard ¼ inch pipe. In an aspect, at least a portion of the input tube comprises standard ⅛ inch pipe.

In some embodiments, the system further includes a valve (not shown) positioned between the first end 1522 and the second end 1524 of the input tube 1520. In an aspect, the valve positioned between the first end 1522 and the second 1524 of the input tube 1520 comprises a ball valve with a spring return handle. In some embodiments, the input tube 1520 is at least partially covered with an insulation material. In an aspect, the insulation material comprises a rubberized plastic coating. Further non-limiting aspects of an input tube for use in devices and systems for dry ice production are described above herein.

In some embodiments, system 1500 further includes at least one second first opening defined by the lid structure and at least one second input tube sized to traverse at least partially through the at least one second first opening defined by the lid structure, the at least one second input tube having a first end and a second end forming a flow conduit for pressurized carbon dioxide into the storage container 1505, the first end of the at least one second input tube having a coupling for attachment to a source of carbon dioxide, the second end of the at least one second input tube traversing at least partially through the at least one second first opening defined by the lid structure and including at least one aperture having a diameter smaller than an inner diameter of the at least one second input tube.

The second end 1524 of the input tube 1520 traverses at least partially through the first opening defined by the lid structure 1510 and includes at least one aperture (not shown) having a diameter smaller than an inner diameter of the input tube 1520. In an aspect, the at least one aperture at the second end 1524 of the input tube 1520 comprises a single aperture at the extreme end of the second end 1524 of the input tube 1520. For example, the at least one aperture can include a hole of a specific diameter punched or machined through a closed second end of the input tube. In an aspect, the at least one aperture at the second end 1524 of the input tube 1520 comprises an array of two or more apertures at the extreme end of the second end 1524 of the input tube 1520. For example, the second end of the input tube can include an array of holes of specific diameter punched or machined into the extreme end of the input tube. In an aspect, the at least one aperture at the second end 1524 of the input tube 1520 comprises at least one aperture defined by a wall of the input tube at the second end 1524 of the input tube 1520. For example, the input tube can have one or more openings defined by the wall of the input tube. In an aspect, the at least one aperture at the second end 1524 of the input tube 1520 is associated with a fitting attachable to the second end 1524 of the input tube 1520. In an aspect, system 1500 includes a first and at least one second fitting interchangeably attachable to the second end of the input tube, the first fitting having at least one aperture of a first size, the at least one second fitting having at least one aperture of a second size. In some embodiments, a system for dry ice production is packaged and/or shipped with a series of fittings attachable to the second end of the input tube, each of the series of fittings including a different aperture size and/or number to allow a user to control speed of dry ice formation in the storage container.

In some embodiments, the diameter of the at least one aperture at the second end 1524 of the input tube 1520 is sized proportional to a filling rate. In some embodiments, the diameter of the at least one aperture at the second end 1524 of the input tube 1520 is sized inversely proportional to pressure in the input tube. In general, the aperture size is at least less than the inner diameter of the input tube and at most 0.5 inches. In an aspect, the aperture is about 0.001 inches to about 0.5 inches in diameter. It is also contemplated that in some embodiments, the aperture is smaller than 0.001 inches or larger than 0.25 inches in diameter, depending upon the application and size of the storage container. In some embodiments, the at least one aperture having a diameter smaller than the inner diameter of the input tube is about 0.062 inches in diameter. Further non-limiting aspects of the at least one aperture in the input tube for use in devices and systems for dry ice production are described above herein.

System 1500 includes a vent tube 1530 sized to pass through and seal within the second opening defined by the lid structure 1510, the vent tube 1530 having a first end 1532 and a second end 1534 forming a flow conduit for gaseous carbon dioxide. The first end 1532 of the vent tube 1530 is configured to fit into the storage container 1505. In an aspect, vent tube 1530 is formed from a metal or metal alloy. In an aspect, the vent tube 1530 is formed from at least one of copper, copper alloy, aluminum, stainless steel, or carbon steel. In some embodiments, the vent tube 1530 is formed from a plastic or polymer material. In some embodiments, the vent tube 1530 is formed from a composite material. In an aspect, the vent tube 1530 is formed from a plastic or polymer material having a glass transition temperature below 0° C. In an aspect, the lid structure 1510 and the vent tube 1530 are formed as a single manufactured unit.

In some embodiments, the second end 1534 of the vent tube 1530 is bent at an angle from vertical away from the input tube 1520 to deflect the gaseous carbon dioxide. The vent tube is bent away from the input tube so as to vent the gaseous carbon dioxide away from the user as it escapes through the vent tube. In an aspect, the second end 1534 of the vent tube 1530 is bent at a 45 degree angle from vertical away from the input tube 1520. In an aspect, the second end 1534 of the vent tube 1530 is bent at about a 15 degree angle to about a 90 degree angle from vertical away from the input tube 1520. Further non-limiting aspects of a vent tube for use in devices and systems for dry ice production are described above herein.

In an aspect, the second end 1534 of the vent tube 1530 includes at least one deflector positioned to deflect the gaseous carbon dioxide. For example, the at least one deflector can include a plate or other attachment positioned at or near the second end of the vent tube to deflect, bend, deviate, or redirect the venting gaseous carbon dioxide away from a user. In an aspect, the at least one deflector is moveable so as to control the direction of the venting gaseous carbon dioxide. For example, the at least one deflector can include a moveable plate or other attachment that can be adjusted to controllably deflect, bend, deviate, or redirect the venting gaseous carbon dioxide. In an aspect, the second end 1534 of the vent tube 1530 includes at least one internal deflector positioned in the flow conduit of the vent tube 1530 to deflect the gaseous carbon dioxide. For example, the deflector can be sized and positioned to deflect, bend, deviate, or redirect escaping gaseous carbon dioxide away from a user. In an aspect, the deflector includes at least one plate positioned at an angle within the vent tube to deflect, bend, deviate, or redirect the venting gaseous carbon dioxide. In an aspect, the deflector is moveable so as to control the direction of the venting gaseous carbon dioxide. In some embodiments, the deflector includes a baffle.

In some embodiments, the system further includes a vent tube extender sized for attachment to the second end 1534 of vent tube 1530. The vent tube extender when attached to the second end of the vent tube is configured to expel the vented gaseous carbon dioxide farther away from a user as the storage container is filled with dry ice. In some embodiments, the vent tube extender comprises a second lower vent tube coupled to the second end 1534 of the vent tube 1530. In some embodiments, the second end 1534 of the vent tube 1530 includes an attachment site for a vent sock or hose. In some embodiments, system 1500 includes a vent sock or hose attachable to the second end 1534 of the vent tube 1530. The vent sock or hose is intended to further vent escaping gaseous carbon dioxide away from the user. In an aspect, the vent sock or hose is of sufficient length to vent the escaping gaseous carbon dioxide out a window or into an adjacent unoccupied room.

System 1500 further includes a lower vent tube 1540 sized to extend into an interior portion of the storage container 1505. The lower vent tube 1540 has an open first end 1542 sized to couple to the first end 1532 of the vent tube 1530. In some embodiments, the second end 1544 of lower vent tube 1540 is open. In some embodiments, the second end 1544 of lower vent tube 1540 is closed. A wall of the lower vent tube 1540 defines a plurality of openings configured to allow passage of the gaseous carbon dioxide from the storage container 1505, through the lower vent tube 1540, and out the vent tube 1530.

In an aspect, the lower vent tube 1540 is formed from a metal or metal alloy. In an aspect, the lower vent tube 1540 is formed from a plastic or polymer material. In an aspect, the lower vent tube 1540 is formed from a composite material. In an aspect, the lower vent tube 1540 is formed from a plastic or polymer material with a glass transition temperature below 0° C. Further aspects as to the materials for forming a lower vent tube for a use in devices and systems for dry ice production have been described above herein.

In some embodiments, lower vent tube 1540 of system 1500 is at least partially covered with a porous material, wherein the porous material defines openings sized to at least partially prevent passage of solid carbon dioxide flakes into the interior portion of the lower vent tube 1540 and the vent tube 1530. For example, the lower vent tube can be at least partially covered with a woven, knitted, or perforated porous material. In some embodiments, lower vent tube 1540 of system 1500 is at least partially covered with a mesh material, wherein the mesh material defines openings sized to at least partially prevent passage of solid carbon dioxide flakes into the interior portion of the lower vent tube 1540 and the vent tube 1530. In an aspect, the opening size of the porous or mesh material ranges from about 0.0005 to about 0.055 inches. Ideally, the opening size of the porous or mesh material is large enough to allow gas to pass through the porous or mesh material and into the lower vent tube, but small enough to prevent flakes of formed solid carbon dioxide or dry ice passing though the porous or mesh material and into the lower vent tube. In an aspect, the porous or mesh material has an opening size of 0.010 square inch. In an aspect, the mesh material is formed from a metal or metal alloy. In an aspect, the mesh material is formed from a plastic or polymer material. Further non-limiting aspects of porous and mesh materials for use in devices and system for dry ice production have been described above herein.

In an aspect, system 1500 includes at least one additional lower vent tube sized to extend into the interior portion of the storage container 1505, the at least one additional lower vent tube having an open first end sized to couple to the first end of the vent tube, a wall of the at least one additional lower vent tube defining a plurality of openings sized to allow passage of the gaseous carbon dioxide from the storage container, through the lower vent tube, and out the vent tube. For example, a dry ice production system packaged for shipment can include the lid structure, input tube, vent tube, and at least two lower vent tubes. In some embodiments, the at least one additional lower vent tube is identical in shape and composition to the lower vent tube. In some embodiments, the at least one additional lower vent tube varies in shape and/or composition from the lower vent tube. For example, the at least one additional lower vent tube may be shorter or longer in length than the lower vent tube. For example, the at least one additional lower vent tube may be wider or narrower in diameter or width relative to the lower vent tube. For example, the at least one additional lower vent tube may have more or less openings than the lower vent tube.

In an aspect, the at least one additional lower vent tube includes a mesh or porous material covering at least a portion of the at least one additional lower vent tube. In some embodiments, the composition of and the openings in the porous or mesh material are the same for the lower vent tube and the at least one additional lower vent tube. In some embodiments, the composition of and/or the openings in the porous or mesh material are different for the lower vent tube and the at least one additional lower vent tube.

In an aspect, the at least one additional lower vent tube is sized for attachment to the second end 1534 of the vent tube 1530. For example, the additional lower vent tube can be configured to extend the vent tube so as to vent the escaping gaseous carbon dioxide further away from a user during dry ice formation.

In some embodiments, lower vent tube 1540 comprises a storage tube sized to fit entirely within the storage container 1505 and to hold at least one removable sample holder, the storage tube having an open first end sized to couple to the first end 1532 of the vent tube 1530 and a closed second end, a wall of the storage tube defining a plurality of openings sized to allow passage of the gaseous carbon dioxide from the storage container 1505, through the storage tube, and out the vent tube 1530. Further non-limiting aspects of a storage tube for use in devices and system for dry ice production have been described above herein.

In an aspect, system 1500 further includes at least one additional storage tube. The at least one additional storage tube is sized to fit entirely within the storage container and to hold at least one removable sample holder. For example, a dry ice production system packaged for shipment can include the lid structure, input tube, vent tube, and at least two storage tubes. In some embodiments, the at least one additional storage tube is identical in shape and composition to a first storage tube. In some embodiments, the at least one additional storage tube varies in shape and/or composition from the first storage tube. For example, the at least one additional storage tube may be shorter or longer in length than the first storage tube. For example, the at least one additional storage tube may be wider or narrower in diameter or width relative to the first storage tube. For example, the at least one additional storage tube may have more or less openings or openings of varied size relative to the first storage tube.

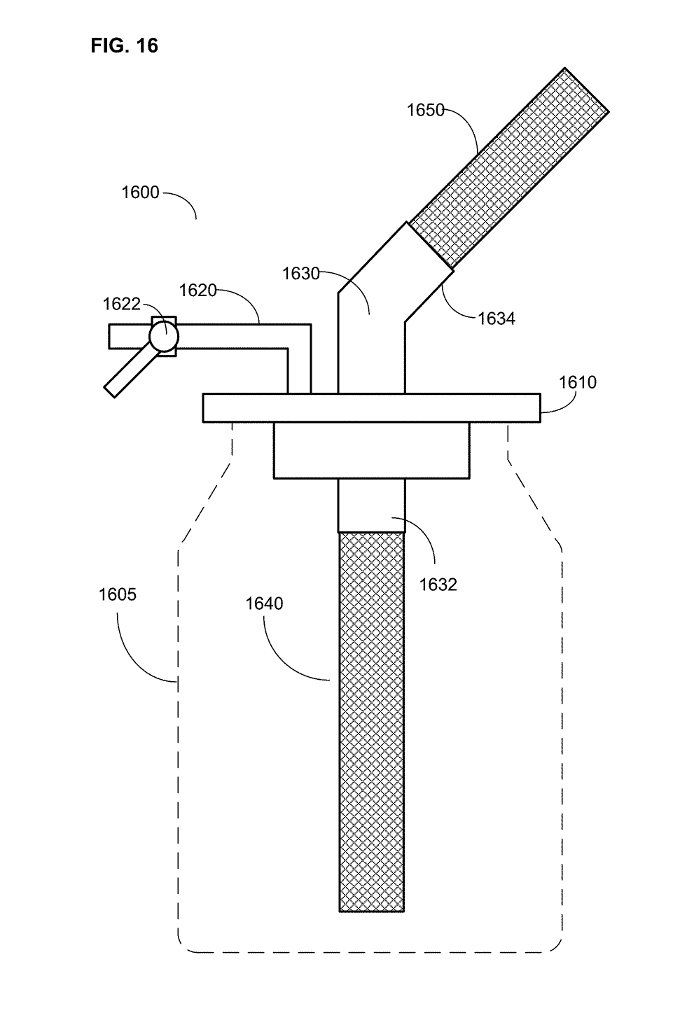

FIG. 16 illustrates embodiments of a system for dry ice production. System 1600 includes a lid structure 1610, input tube 1620, vent tube 1630, and lower vent tube 1640. Lid structure 1610 is sized for placement over an opening to a storage container 1605. Input tube 1620 includes a first and a second end forming a flow conduit for pressurized carbon dioxide. The second end of the input tube 1620 includes at least one aperture (not shown) with a diameter smaller than an inner diameter of the input tube 1620. Input tube 1620 further includes a valve 1622 positioned between the first end and the second end of the input tube 1620. In some embodiments, the valve 1622 positioned between the first end and the second end of the input tube 1620 comprises a ball valve with a spring return handle. In some embodiments, the input tube 1620 is at least partially covered with an insulation material. In an aspect, the insulation material comprises a rubberized plastic coating.

System 1600 includes vent tube 1630 having a first end 1632 and a second end 1634. The second end 1634 of vent tube 1630 is bent at an angle from vertical away from input tube 1620. The first end 1632 of vent tube 1630 is sized to couple with lower vent tube 1640. In some embodiments, system 1600 further includes a vent extender 1650. In some embodiments, vent extender 1650 is a second lower vent tube sized to couple to the second end 1634 of vent tube 1630. In some embodiments, vent extender 1650 is a vent sock or hose. For example, a vent sock or hose can be attached to the second end of the vent tube to allow gaseous carbon dioxide venting from the storage container to vent at a distance (e.g., out a window or to another room) from a user.

### Storage Container

In some embodiments, the system further includes a storage container. In an aspect, the system includes a vacuum insulated storage container. The storage container is intended to hold biological samples under the formed dry ice for a short period of time. In some embodiments, the biological samples are stored independent of the lower vent tube. For example, the biological samples can be placed on the bottom of the storage container so as to maximize the amount of coverage with dry ice. In some embodiments, the biological samples are stored in the lower vent tube, e.g., a storage tube. In some embodiments, the storage container is sized to hold the storage tube containing at least one sample cane and be packed with dry ice formed using the device and systems described herein. The lid structure of the dry ice forming device or system is sized to fit over an opening to the storage container. The lid structure is sized to completely cover an opening to the storage container. The storage container can include an insulated beverage container, e.g., a vacuum flask, with a screw cap top to keep the produced dry ice and the stored samples cold for a reasonable amount of time. For example, the storage container can include a vacuum insulated liquid storage container, a thermos, or a Dewar. In an aspect, the storage container includes a foam insulated storage container.

The storage container has an inner length sufficient to accommodate a lower vent tube. The inner length of the storage container is sufficient to accommodate a lower vent tube of length ranging from about 2 inches to about 15 inches. In an aspect, the inner length of the storage container is sufficient to accommodate a lower vent tube of about 11 inches in length. For example, a standard half gallon vacuum insulated bottle with dimensions an inner diameter of 4.5 inches, an outer diameter of 5.5 inches, and a length of 14.6 inches.

### Formed as a Single Unit

In some embodiments, a device for dry ice production includes a lid structure and a vent tube formed as a single manufactured unit, wherein the lid structure has a top surface and a bottom surface, the bottom surface sized for placement over an opening to a vacuum insulated storage container, the lid structure defining a first opening with a diameter configured to accept an input tube attached to a source of carbon dioxide, and wherein the vent tube defines a second opening through the lid structure and has a first end and a second end forming a flow conduit for gaseous carbon dioxide out of the storage container, the first end of the vent tube extending beyond the bottom surface of the lid structure and sized to fit within the storage container and couple with a lower vent tube, the second end of the vent tube extending beyond the top surface of the lid structure.

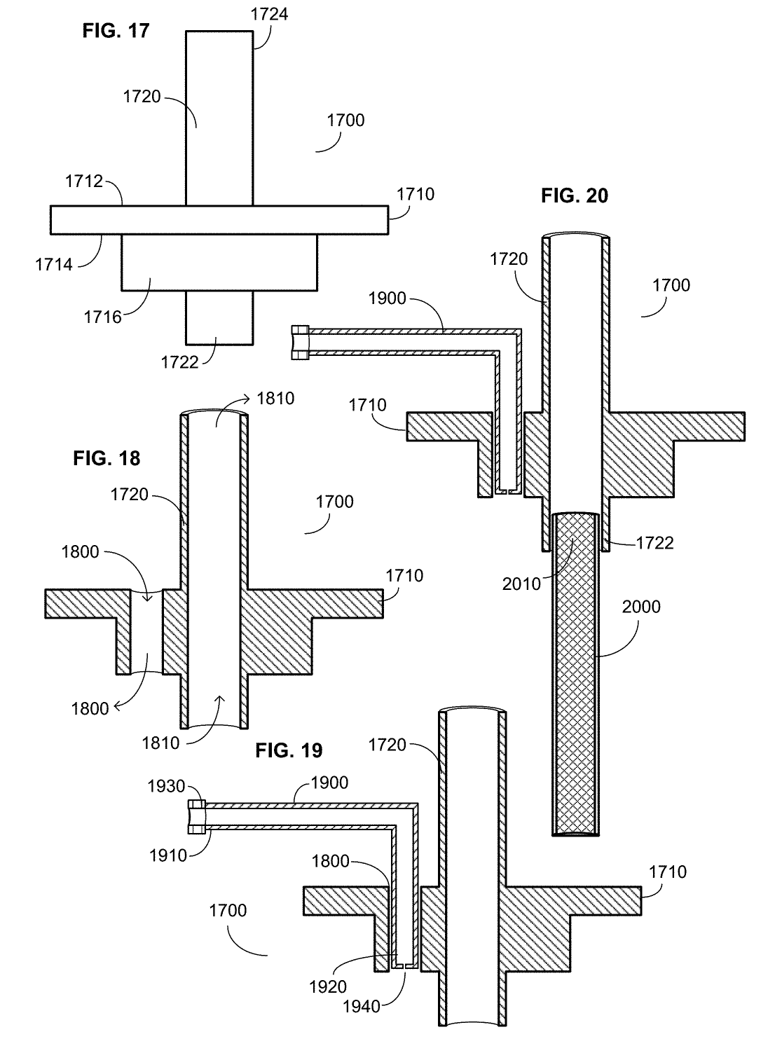

FIGS. 17-20 illustrate aspects of a device for dry ice production including a lid structure and a vent tube formed as a single manufactured unit. FIG. 17 shows device 1700 for dry ice production including a lid structure 1710 and a vent tube 1720. Lid structure 1710 includes a top surface 1712 and a bottom surface 1714. The bottom surface 1714 is sized for placement over an opening to a storage container, e.g., a vacuum insulated storage container. In this non-limiting example, device 1700 further includes a lower portion 1716 sized to fit into the opening of the storage container. Device 1700 further includes vent tube 1720 having a first end 1722 and a second end 1724 forming a flow conduit for gaseous carbon dioxide out of the storage container. The first end 1722 of the vent tube 1720 extends beyond the bottom surface 1714 of the lid structure 1710. In this non-limiting example, the first end 1722 of the vent tube 1720 extends beyond the lower portion 1716 of the lid structure 1710. The second end 1724 of the vent tube 1720 extends beyond the top surface 1712 of the lid structure 1710.

FIG. 18 shows a cross-section view through device 1700. The lid structure 1710 and the vent tube 1720 are shown formed as a single unit as exemplified by the slanted line fill. The lid structure 1710 defines a first opening 1800 with a diameter configured to accept an input tube attached to a source of carbon dioxide. The vent tube 1720 defines a second opening 1810 through the lid structure 1710 and forms a flow conduit for gaseous carbon dioxide.

In some embodiments, the lid structure and the vent tube are formed as a single manufactured unit using an injection molding process. For example, the lid structure and the vent tube can be formed by injection molding from polyethylene. In some embodiments, the lid structure and the vent tube are formed as a single manufactured unit using a three-dimensional (3-D) printing manufacturing process. Other non-limiting examples of materials for injection molding and/or 3-D printing include, but are not limited to, acrylonitrile butadiene styrene (ABS), ABS/polycarbonate (ABS/PC), engineered thermoplastic polyurethane ETPU, high density polyethylene (HDPE), light crystal polymer (LCD), low density polyethylene (LDPE), linear low density polyethylene (LLDPE), nylon, polybutylene terephthalate (PBT), polycarbonate (PC), PC/PBT, polyetheretherketone (PEEK), polyetherimide (PEI), thermoplastic polyester resin (PET), co-polyester (PETG), acrylic (PMMA), polypropylene (PP), polyphenylene ether/high impact polystyrene (PPE/PS, polyphenylene sulfide (PPS), polystyrene (PS), polysulfone (PSU), styrene butadiene (SB), thermoplastic elastomer/thermoplastic vulcanizate (TPE/TPV), and/or thermoplastic polyurethane elastomer (TPU). In an aspect, the lid structure and the vent tube are formed as a single manufactured unit from a material having a low thermal conductivity value. In an aspect, the lid structure and the vent tube are formed as a single manufactured unit from a material having a glass transition temperature below 0° C.

In some embodiments, device 1700 further includes the input tube sized to traverse at least partially through the first opening defined by the lid structure, the input tube having a first end and a second end forming a flow conduit for pressurized carbon dioxide into the storage container, the first end of the input tube having a coupling for attachment to the source of carbon dioxide, the second end of the input tube traversing at least partially through the first opening defined by the lid structure and including at least one aperture having a diameter smaller than an inner diameter of the input tube.

FIG. 19 illustrates a cross-section view of further aspects of device 1700 including an input tube 1900. Device 1700 is shown with lid structure 1710 and vent tube 1720 formed as a single unit as exemplified by the slanted line fill. Input tube 1900 is sized to traverse at least partially through the first opening 1800 defined by the lid structure 1710. The input tube 1900 has a first end 1910 and a second end 1920 forming a flow conduit for pressurized carbon dioxide into the storage container. The first end 1910 of the input tube 1900 has a coupling 1930 for attachment to a source of carbon dioxide. The second end 1920 of the input tube 1900 traverses at least partially through the first opening 1800 defined by the lid structure 1710 and includes at least one aperture 1940 having a diameter smaller than an inner diameter of the input tube 1900. Non-limiting aspects of an input tube have been described above herein.

In some embodiments, device 1700 further includes a lower vent tube sized to extend into an interior portion of the storage container, the lower vent tube having an open first end sized to couple with the first end of the vent tube, a wall of the lower vent tube defining a plurality of openings sized to allow passage of the gaseous carbon dioxide from the storage container, through the lower vent tube, and out the vent tube.

FIG. 20 illustrates a cross-section view of further aspects of device 1700 including input tube 1900 and a lower vent tube 2000. Device 1700 is shown with lid structure 1710 and vent tube 1720 formed as a single unit as exemplified by the slanted line fill. Input tube 1900 is sized to traverse at least partially through a first opening defined by the lid structure 1710. The lower vent tube 2000 has an open first end 2010 sized to couple with the first end 1722 of vent tube 1720. A wall of the lower vent tube 2000 defines a plurality of openings configured to allow passage of the gaseous carbon dioxide from the storage container, through lower vent tube 2000, and out the vent tube 1720. In some embodiments, at least a portion of the lower vent tube is covered by a porous or mesh material. Non-limiting aspects of a lower vent tube have been described above herein.

In some embodiments, the lower vent tube comprises a storage tube sized to fit entirely within the storage container and to hold at least one removable sample holder, the storage tube having an open first end sized to couple to the first end of the vent tube and a closed second end, a wall of the storage tube defining a plurality of openings sized to allow passage of the gaseous carbon dioxide from the storage container, through the storage tube, and out the vent tube. In some embodiments, at least a portion of the storage tube is covered by a porous or mesh material. Non-limiting aspects of a storage tube have been described above herein.

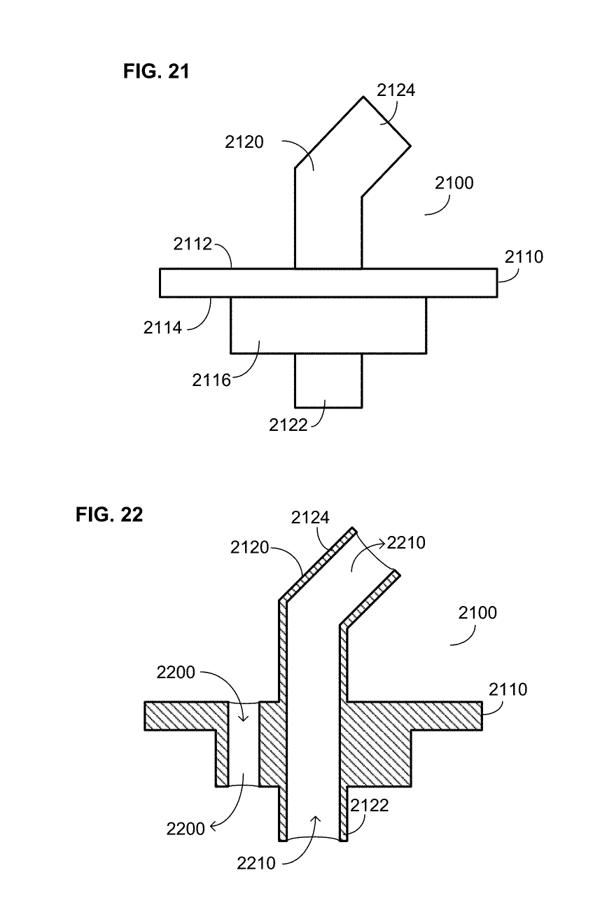

In some embodiments, the second end of the vent tube extending beyond the top surface of the lid structure is bent at an angle from vertical away from the first opening defined by the lid structure. FIGS. 21 and 22 illustrate a non-limiting example. FIG. 21 is a side view of device 2100 including lid structure 2110 and vent tube 2120 formed as a single manufactured unit. Lid structure 2110 has a top surface 2112 and a bottom surface 2114, the bottom surface 2114 sized for placement over an opening to a storage container. Lid structure 2110 further includes lower portion 2116. Device 2100 further includes vent tube 2120 having a first end 2122 and a second end 2124 forming a flow conduit for gaseous carbon dioxide through the lid structure 2110. The first end 2122 of vent tube 2120 is sized to couple with a lower vent tube. The second end 2124 of vent tube 2120 extending beyond the top surface 2112 of the lid structure 2110 is bent at an angle.

FIG. 22 illustrates further aspects of device 2100. Shown is a cross-section view through device 2100. The lid structure 2110 and the vent tube 2120 are shown formed as a single manufactured unit as exemplified by the slanted line fill. The lid structure 2110 defines a first opening 2200 with a diameter configured to accept an input tube attached to a source of carbon dioxide. The vent tube 2120 defines a second opening 2210 from the first end 2122 to the second end 2124 of the vent tube 2120 through the lid structure 2110 and forms a flow conduit for gaseous carbon dioxide. The second end 2124 of vent tube 2120 is bent at an angle from vertical away from the first opening 2200 defined by the lid structure 2110.

In some embodiments, device 2100 further includes an input tube sized to traverse at least partially through the first opening defined by the lid structure, the input tube having a first end and a second end forming a flow conduit for pressurized carbon dioxide into the storage container, the first end of the input tube having a coupling for attachment to the source of carbon dioxide, the second end of the input tube traversing at least partially through the first opening defined by the lid structure and including at least one aperture having a diameter smaller than an inner diameter of the input tube.

In some embodiments, device 2100 further includes a lower vent tube sized to extend into an interior portion of the storage container, the lower vent tube having an open first end sized to couple with the first end of the vent tube, a wall of the lower vent tube defining a plurality of openings sized to allow passage of the gaseous carbon dioxide from the storage container, through the lower vent tube, and out the vent tube. In an aspect, at least a portion of the lower vent tube is covered with a porous or mesh material.

In some embodiments, a system for dry ice production includes a lid structure sized for placement over an opening to a storage container, the lid structure defining an opening; a vent tube sized to pass through and seal within the opening defined by the lid structure, the vent tube have a first end and a second end forming a flow conduit for gaseous carbon dioxide, the first end of the vent tube sized to fit into the opening to the storage container; a lower vent tube sized to extend into an interior portion of the storage container, the lower vent tube having a first end sized to couple to the first end of the vent tube, and a wall of the lower vent tube defining a plurality of openings sized to allow passage of the gaseous carbon dioxide from the storage container, through the lower vent tube, and out the vent tube; and an input tube sized to traverse through an interior portion of the vent tube, the input tube having a first end and a second end forming a flow conduit for pressurized carbon dioxide into the storage container, the first end of the input tube having a coupling for attachment to a source of carbon dioxide, the second end of the input tube sized to extend beyond the second end of the lower vent tube and including at least one aperture having a diameter smaller than an inner diameter of the input tube.

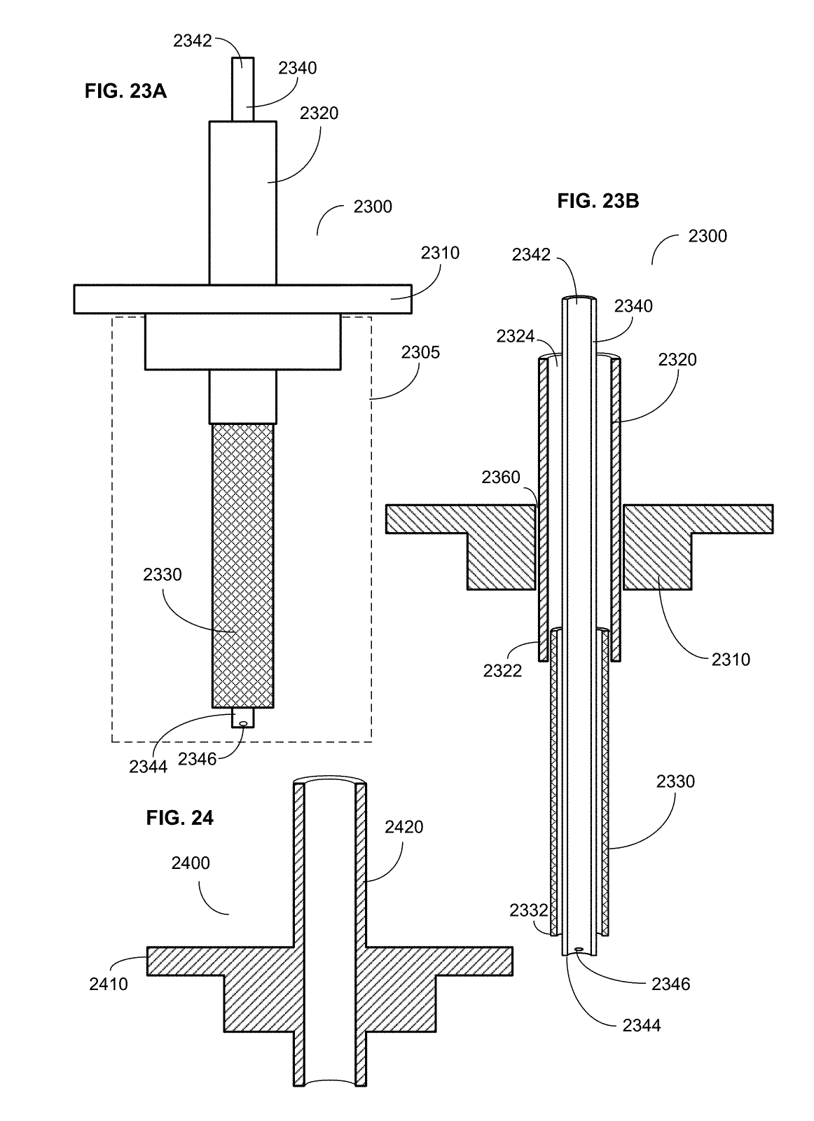

FIGS. 23A and 23B illustrate aspects of a system for dry ice production. FIG. 23A shows system 2300 including lid structure 2310, vent tube 2320, lower vent tube 2330, and input tube 2340. Lid structure 2310 is sized to cover an opening to a storage container 2305. Input tube 2340 includes a first end 2342 and a second end 2344. The second end 2344 of input tube 2340 further includes at least one aperture 2346. FIG. 23B illustrates further aspects of system 2300. Shown is a cross-section view through system 2300. Lid structure 2310 defines an opening 2360 through which vent tube 2320 extends. Also shown is lower vent tube 2330 coupled to the first end 2322 of vent tube 2320. Input tube 2340 is shown passing through vent tube 2320 and lower vent tube 2330. The first end 2342 of the input tube 2340 extends beyond the second end 2324 of vent tube 2320 and the second end 2344 of the input tube 2340 extends beyond the second end 2332 of the lower vent tube 2330. The second end 2344 of the input tube 2340 further includes at least one aperture 2346. Dry ice is formed in the storage container as pressurized carbon dioxide passes through the input tube 2340 from first end 2342 to second end 2344 and out the at least one aperture 2346.

In some embodiments, the lid structure and the vent tube are formed as a single manufactured unit. A non-limiting example is shown in FIG. 24. A single manufactured unit 2400 is shown in cross-section and includes the lid structure 2410 and the vent tube 2420 defining an opening through the lid structure. Single manufactured unit 2400 can be combined with lower vent tube 2330 and input tube 2340 of FIGS. 23A and 23B to form a system for dry ice production.

In some embodiments, the vent tube and the lower vent tube form a single manufactured unit. For example, a single vent tube can be sized to pass through a lid structure, a lower portion of the single vent tube sized for extension into a storage container and including a plurality of openings sized to allow passage of gaseous carbon dioxide from the storage container and out the single vent tube. After dry ice filling, the single vent tube is removed, leaving a cavity in the dry ice for use in storing samples.

In some embodiments, a device for dry ice production includes a lid structure having a top surface and a bottom surface, the bottom surface of the lid structure sized for placement over an opening to a storage container, the lid structure defining a first opening and a second opening, the first opening forming a flow conduit through the lid structure from the top surface to the bottom surface, the first opening having at or near the top surface of the lid structure an attachment site for an input tube attached to a source of carbon dioxide, wherein an inner diameter of the first opening at or near the bottom surface of the lid structure is smaller than an inner diameter of the first opening at or near the top surface of the lid structure; and a vent tube sized to pass through and seal within the second opening defined by the lid structure, the vent tube having a first end and a second end forming a flow conduit for gaseous carbon dioxide, the first end of the vent tube sized to fit into the opening to the storage container.

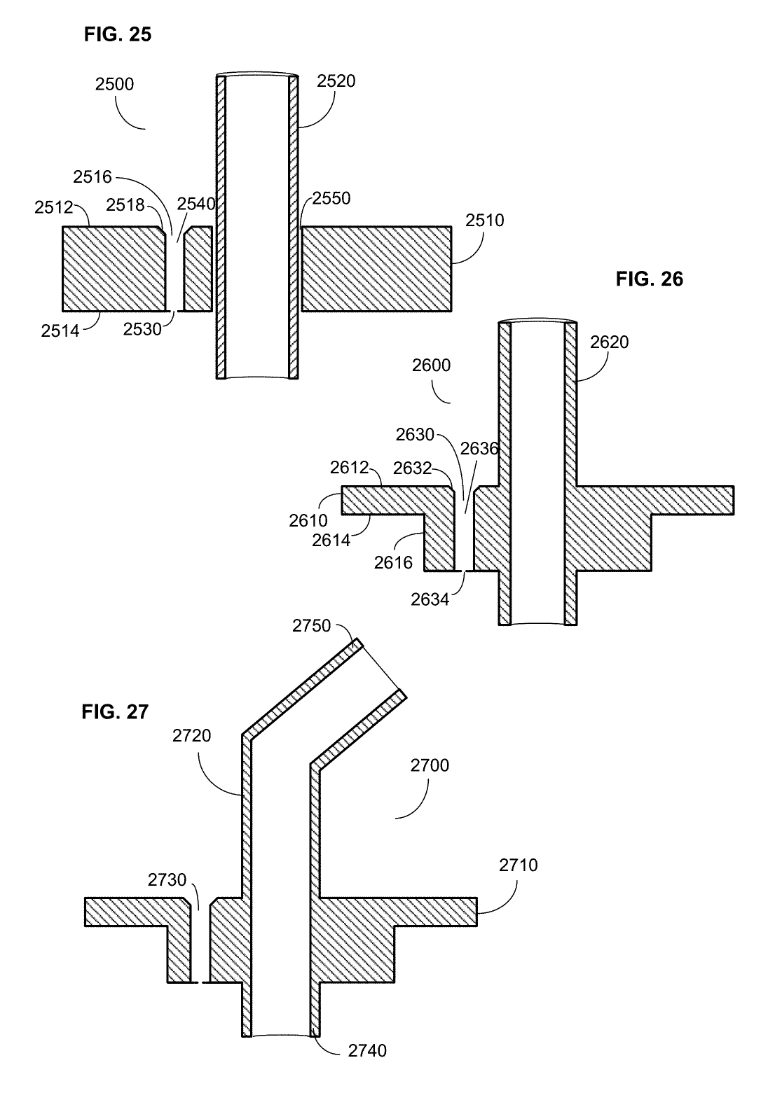

FIGS. 25-27 illustrate aspects of a device for dry ice production. FIG. 25 shows a cross-section view through device 2500 including lid structure 2510 and vent tube 2520. Lid structure 2510 has a top surface 2512 and a bottom surface 2514, wherein the bottom surface 2514 is sized to cover an opening to a storage container, e.g., a vacuum insulated storage container. Lid structure 2510 defines a first opening 2516 forming a flow conduit through the lid structure 2510 from the top surface 2512 to the bottom surface 2514. The first opening 2516 further includes at or near the top surface 2512 of the lid structure 2510 an attachment site 2518 for an input tube attached to a source of carbon dioxide. The inner diameter 2530 of the first opening 2516 at or near the bottom surface 2514 of the lid structure 2510 is smaller than an inner diameter 2540 of the first opening 2516 at or near the top surface 2512 of the lid structure 2510. Vent tube 2520 is shown passing through second opening 2550 of lid structure 2510. The lid structure is formed from a material of sufficient strength and thickness to withstand operational pressures of up to 1000 psi.

In some embodiments, the lid structure and the vent tube are formed as a single manufactured unit, the vent tube defining the second opening through the lid structure, the first end and the second end of the vent tube forming the flow conduit for the gaseous carbon dioxide out of the storage container, the first end of the vent tube extending beyond the bottom surface of the lid structure and sized to fit within the storage container, the second end of the vent tube extending beyond the top surface of the lid structure. A non-limiting example is shown in FIG. 26. FIG. 26 shows a cross-section view through device 2600 including a lid structure 2610 and a vent tube 2620 formed as a single manufactured unit (as represented by the slanted line fill). Lid structure 2610 has a top surface 2612, a bottom surface 2614 sized to cover an opening to a storage container, and a lower portion 2616. Lid structure 2610 defines a first opening 2630 forming a flow conduit through the lid structure 2610 from the top surface 2612 through to the bottom of the lower portion 2616. The first opening 2630 further includes at or near the top surface 2612 of the lid structure 2610 an attachment site 2632 for an input tube attached to a source of carbon dioxide. The inner diameter 2634 of the first opening 2630 at or near the bottom surface of the lower portion 2616 of the lid structure 2610 is smaller than an inner diameter 2636 of the first opening 2630 at or near the top surface 2612 of the lid structure 2610. The vent tube 2620 defines an opening through the lid structure 2610, a first end of the vent tube 2620 extending below the lower portion 2616 of the lid structure 2610 and a second end of the vent tube 2620 extending above the top surface 2612 of the lid structure 2610.

FIG. 27 illustrates a further embodiment of a device for dry ice production. FIG. 27 shows a cross-section through device 2700 including a lid structure 2710 and a vent tube 2720 formed as a single manufactured unit (as represented by the slanted line fill). The lid structure 2710 of device 2700 includes the first opening 2730 defined by the lid structure 2710 and associated inner diameters as described for device 2600 in FIG. 26. The vent tube 2720 of device 2700 includes a first end 2740 and a second end 2750 forming a flow conduit for gaseous carbon dioxide. The second end 2750 of vent tube 2720 is bent at an angle from vertical away from the first opening defined by the lid structure.

Devices 2500, 2600, and 2700 have a lid structure with a first opening have an attachment site for an input tube attached to a source of carbon dioxide. In some embodiments, the attachment site is sized for fitted insertion of an end of the input tube. In some embodiments, the attachment site includes threads machined into the first opening at or near the top surface of the lid structure, the threads compatible with a threaded fitting associated with an end of the input tube. In some embodiments, the attachment site includes a fitting incorporated into the first opening at or near the top surface of the lid structure. For example, a threaded fitting (e.g., a brass fitting) at least partially inserted into the first opening at the top surface of the lid structure and fixed by welding, glue, pressure fitting, or other means of permanently attaching the fitting to the lid structure.

In some embodiments, the devices 2500, 2600, and 2700 of FIGS. 25-27 further include a lower vent tube sized to extend into an interior portion of the storage container, the lower vent tube having an open first end sized to couple to the first end of the vent tube, a wall of the lower vent tube defining a plurality of openings sized to allow passage of the gaseous carbon dioxide from the storage container, through the lower vent tube, and out the vent tube. Non-limiting aspects of lower vent tubes have been described above herein. In some embodiments, the lower vent tube is at least partially covered by a porous or mesh material.

### Example 1

### A Dry Ice System

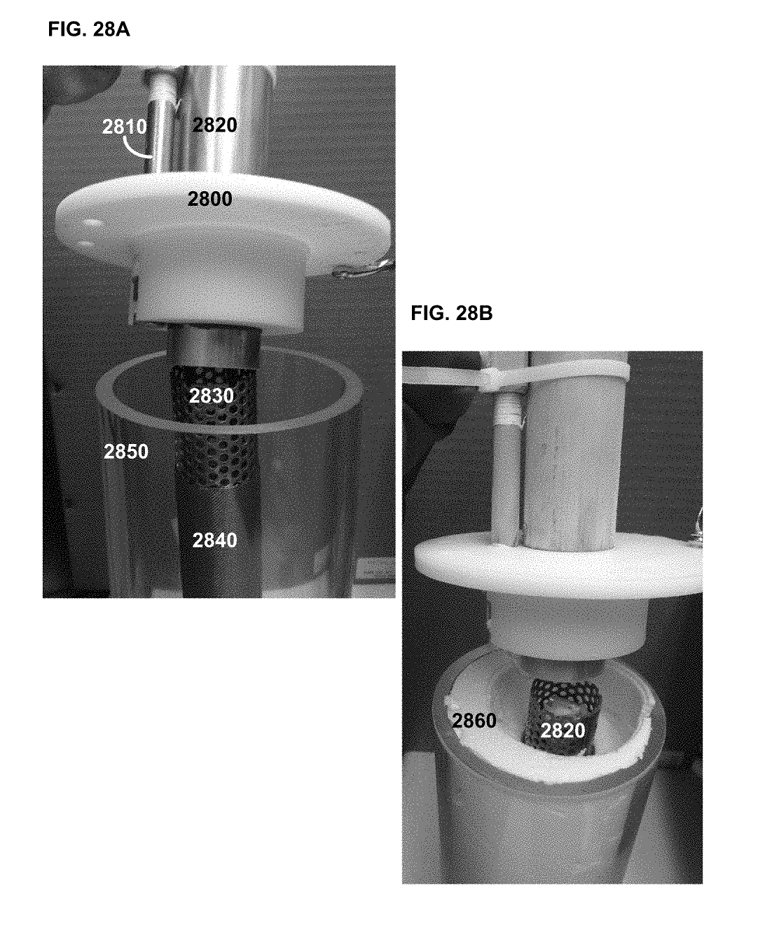

A non-limiting example of a system for dry ice production is described herein and illustrated in the photographs of FIGS. 28A and 28B. The system includes a lid structure 2800, an input tube 2810, a vent tube 2820, and a lower vent tube 2830 covered at least partially covered with a mesh material 2840. To form the lid structure, a first disk (˜5-6 inches in diameter) was cut from a ½ inch slab of polyethylene. A second disk was cut from a 2 inch slab of polyethylene. The diameter of the second disk was cut to a diameter to just fit inside an opening to a standard 2 liter thermos (approximately 3 inches). The two slabs were centered relative to one another and adhered together. Two openings where cut through the lid structure to form the first and second openings. The first opening was sized in diameter to accommodate a ¼ inch copper alloy/brass nominal pipe size. The brass tubing extended out of the first opening perpendicular to the surface of the polyethylene disk for about 6 inches. A union elbow fitting was used to create a 90 degree turn in the brass tubing. The brass tubing was further fitted with a standard in-line ball valve. The second end of the brass tubing includes a fitting with a small diameter aperture or orifice (approximately 0.062 inches in diameter).

The second opening in the polyethylene lid structure was cut in diameter to accommodate a vent tube of 1½ inch outer diameter. The vent tube was formed from 1½ inch brass tubing. The first end of the brass tubing extended through the second opening in the lid structure by about 1 inch. The second end of the brass tubing extended vertical for about 6 inches and then was bent at a 45 degree angle away from the input tube.

The lower vent tube 2830 was formed from a perforated metal tube (e.g., a stainless steel perforated exhaust tube) with an outside diameter of 1½ inch. For the purposes of this example, the tube was cut to a length of approximately 11 inches. A metal disk was adhered to the second end of the tube to close that end of the tube. The perforated tube was covered with a metal mesh sheet with openings of about 0.010 square.

### Example 2

### Generating Dry Ice

The lower vent tube 2830 at least partially covered with the mesh material 2840 was placed into a storage container 2850. For the purposes of demonstration and as shown in FIG. 28A, the storage container 2850 was a clear plastic container (e.g., thick-walled Plexiglas) to allow monitoring of dry ice formation. In real world use, a vacuum insulated storage container, e.g., a thermos or Dewar, with a tightly fitting lid would be used for this purpose. The first end 2810 of the vent tube 2820 attached to the lid structure 2800 was fitted over the open end of the lower vent tube 2830. The operator (wearing protective eyewear and/or face shield and insulated gloves) held the lid structure down over the mouth of the storage container with one hand while using the other hand to open the ball valve to start the flow of carbon dioxide from a cylinder of liquefied carbon dioxide. The expansion of the liquid carbon dioxide to atmospheric pressure is used to produce carbon dioxide “snow” at a temperature of −78.5 C. As the liquid carbon dioxide flows, it turns into gas. As the gas flows through the aperture at the end of the input tube, it cools sufficiently to form solid flakes of dry ice, which begin to fill up the internal space of the storage container surrounding the lower vent tube. Gaseous carbon dioxide escaped through the vent tube, which was bent at an angle away from the input tube and the operator. After some time, the ball valve was closed. The formed dry ice was tamped down to compress it into the storage container with a piece of PVP piping with an inner diameter larger than the outer diameter of the lower vent tube. After tamping down, additional carbon dioxide was allowed to flow into the storage container to form additional dry ice. By repeating this process, it was possible to completely fill the space between the lower vent tube and the inner surface of the storage container with dry ice. This is exemplified in FIG. 28B, where dry ice 2860 is shown around the lower vent tube 2820.

### Aspects of the Subject Matter Described Herein are Set Out in the Following Numbered Paragraphs:

1. In some embodiments, a device for dry ice production includes: a lid structure sized for placement over an opening to a storage container, the lid structure defining a first opening and a second opening; an input tube sized to traverse at least partially through the first opening defined by the lid structure, the input tube having a first end and a second end forming a flow conduit for pressurized carbon dioxide into the storage container, the first end of the input tube having a coupling for attachment to a source of carbon dioxide, the second end of the input tube traversing at least partially through the first opening defined by the lid structure and including at least one aperture having a diameter smaller than an inner diameter of the input tube; and a vent tube sized to pass through and seal within the second opening defined by the lid structure, the vent tube having a first end and a second end forming a flow conduit for gaseous carbon dioxide out of the storage container, the first end of the vent tube sized to fit within the storage container and to couple with a lower vent tube.

2. The device of paragraph 1, wherein the lid structure is disk-shaped.

3. The device of paragraph 1, wherein the lid structure is formed from a material having a low thermal conductivity value.

4. The device of paragraph 1, wherein the lid structure is formed from a plastic or polymer material.

5. The device of paragraph 1, wherein the lid structure is formed from a composite material.

6. The device of paragraph 1, wherein the lid structure is formed from a plastic or polymer material with a glass transition temperature below 0° C.

7. The device of paragraph 1, wherein the lid structure is formed from polyethylene.

8. The device of paragraph 1, wherein the lid structure is sized for placement over an opening to a vacuum insulated storage container.

9. The device of paragraph 1, wherein the lid structure includes a lower portion sized to fit into the opening of the storage container.

10. The device of paragraph 1, wherein the input tube is formed from a material with at least one of a strength or a wall thickness sufficient to withstand operational pressures of up to 1000 psi.

11. The device of paragraph 1, wherein the input tube is formed from at least one of copper, copper alloy, or stainless steel.

12. The device of paragraph 1, further including: at least one second first opening defined by the lid structure and at least one second input tube sized to traverse at least partially through the at least one second first opening defined by the lid structure, the at least one second input tube having a first end and a second end forming a flow conduit for pressurized carbon dioxide into the storage container, the first end of the at least one second input tube having a coupling for attachment to a source of carbon dioxide, the second end of the at least one second input tube traversing at least partially through the at least one second first opening defined by the lid structure and including at least one aperture having a diameter smaller than an inner diameter of the at least one second input tube.

13. The device of paragraph 1, wherein the at least one aperture at the second end of the input tube comprises a single aperture at the extreme end of the second end of the input tube.

14. The device of paragraph 1, wherein the at least one aperture at the second end of the input tube comprises an array of two or more apertures at the extreme end of the second end of the input tube.

15. The device of paragraph 1, wherein the at least one aperture at the second end of the input tube comprises at least one aperture defined by a wall of the input tube at the second end of the input tube.

16. The device of paragraph 1, wherein the at least one aperture at the second end of the input tube is associated with a fitting attachable to the second end of the input tube.

17. The device of paragraph 1, wherein the diameter of the at least one aperture at the second end of the input tube is sized proportional to a filling rate.

18. The device of paragraph 1, wherein the diameter of the at least one aperture at the second end of the input tube is sized inversely proportional to pressure in the input tube.

19. The device of paragraph 1, further including: a valve positioned between the first end and the second end of the input tube.

20. The device of paragraph 19, wherein the valve positioned between the first end and the second end of the input tube comprises a ball valve with a spring return handle.

21. The device of paragraph 1, wherein the input tube is at least partially covered with an insulation material.

22. The device of paragraph 21, wherein the insulation material comprises a rubberized plastic coating.

23. The device of paragraph 1, wherein the vent tube is formed from at least one of copper, copper alloy, stainless steel, or aluminum.

24. The device of paragraph 1, wherein the vent tube is formed from a plastic or polymer material.

25. The device of paragraph 1, wherein the vent tube is formed from a composite material.

26. The device of paragraph 1, wherein the vent tube is formed from a plastic or polymer material with a glass transition temperature below 0° C.

27. The device of paragraph 1, wherein the lid structure and the vent tube are formed as a single manufactured unit.

28. The device of paragraph 1, wherein the second end of the vent tube is bent at an angle from vertical away from the input tube to deflect the gaseous carbon dioxide.

29. The device of paragraph 1, wherein the second end of the vent tube is bent at about a 15 degree angle to about a 90 degree angle from vertical away from the input tube.

30. The device of paragraph 1, wherein the second end of the vent tube includes at least one deflector positioned to deflect the gaseous carbon dioxide.

31. The device of paragraph 1, wherein the second end of the vent tube includes at least one internal deflector positioned in the flow conduit of the vent tube to deflect the gaseous carbon dioxide.

32. The device of paragraph 1, wherein the second end of the vent tube includes an attachment site for a vent sock or hose.

33. The device of paragraph 1, further including a lower vent tube sized to extend within an interior portion of the storage container, the lower vent tube having an open first end sized to couple to the first end of the vent tube, a wall of the lower vent tube defining a plurality of openings sized to allow passage of the gaseous carbon dioxide from the storage container, through the lower vent tube, and out the vent tube.

34. The device of paragraph 33, wherein the lower vent tube is a storage tube sized to fit entirely within the storage container and to hold at least one removable sample holder, the storage tube having an open first end sized to couple to the first end of the vent tube and a closed second end, a wall of the storage tube defining a plurality of openings sized to allow passage of the gaseous carbon dioxide from the storage container, through the storage tube, and out the vent tube.

35. The device of paragraph 33, wherein the lower vent tube is formed from a metal or metal alloy.

36. The device of paragraph 33, wherein the lower vent tube is formed from a plastic or polymer material.

37. The device of paragraph 33, wherein the lower vent tube is formed from a composite material.

38. The device of paragraph 33, wherein the lower vent tube is formed from a plastic or polymer material with a glass transition temperature of less than 0° C.

39. The device of paragraph 33, wherein the lower vent tube is at least partially covered with a porous material, wherein the porous material defines openings sized to at least partially prevent passage of solid carbon dioxide flakes into the interior portion of the lower vent tube and the vent tube.

40. The device of paragraph 33, wherein the lower vent tube is at least partially covered with a mesh material, wherein the mesh material defines openings sized to at least partially prevent passage of solid carbon dioxide flakes into the interior portion of the lower vent tube and the vent tube.

41. The device of paragraph 40, wherein the mesh material is formed from a metal or a metal alloy.

42. The device of paragraph 40, wherein the mesh material is formed from a plastic or polymer material.

43. In some embodiments, a system for dry ice production includes: a lid structure sized for placement over an opening to a storage container, the lid structure defining a first opening and a second opening; an input tube sized to traverse at least partially through the first opening defined by the lid structure, the input tube having a first end and a second end forming a flow conduit for pressurized carbon dioxide into the storage container, the first end of the input tube having a coupling for attachment to a source of carbon dioxide, the second end of the input tube traversing at least partially through the first opening defined by the lid structure and including at least one aperture having a diameter smaller than an inner diameter of the input tube; a vent tube sized to pass through and seal within the second opening defined by the lid structure, the vent tube having a first end and a second end forming a flow conduit for gaseous carbon dioxide, the first end of the vent tube sized to fit into the storage container; and a lower vent tube sized to extend into an interior portion of the storage container, the lower vent tube having an open first end sized to couple to the first end of the vent tube, a wall of the lower vent tube defining a plurality of openings sized to allow passage of the gaseous carbon dioxide from the storage container, through the lower vent tube, and out the vent tube.

44. The system of paragraph 43, wherein the lid structure is disk-shaped.

45. The system of paragraph 43, wherein the lid structure is formed from a material having a low thermal conductivity value.

46. The system of paragraph 43, wherein the lid structure is formed from a plastic or polymer material.

47. The system of paragraph 43, wherein the lid structure is formed from a composite material.

48. The system of paragraph 43, wherein the lid structure is formed from a plastic or polymer material with a glass transition temperature below 0° C.

49. The system of paragraph 43, wherein the lid structure is formed from polyethylene.

50. The system of paragraph 43, wherein the lid structure is sized for placement over an opening to a vacuum insulated storage container.

51. The system of paragraph 43, further including: a vacuum insulated storage container.

52. The system of paragraph 43, wherein the lid structure includes a portion sized for fitting into the opening to the storage container.

53. The system of paragraph 43, wherein the input tube is formed from a material with at least one of a strength or a wall thickness sufficient to withstand operational pressures of up to 1000 psi.

54. The system of paragraph 43, wherein the input tube is formed from at least one of copper, copper alloy, or stainless steel.

55. The system of paragraph 43, further including: at least one second first opening defined by the lid structure and at least one second input tube sized to traverse at least partially through the at least one second first opening defined by the lid structure, the at least one second input tube having a first end and a second end forming a flow conduit for pressurized carbon dioxide into the storage container, the first end of the at least one second input tube having a coupling for attachment to a source of carbon dioxide, the second end of the at least one second input tube traversing at least partially through the at least one second first opening defined by the lid structure and including at least one aperture having a diameter smaller than an inner diameter of the at least one second input tube.

56. The system of paragraph 43, wherein the at least one aperture at the second end of the input tube comprises a single aperture at the extreme end of the second end of the input tube.

57. The system of paragraph 43, wherein the at least one aperture at the second end of the input tube comprises an array of two or more apertures at the extreme end of the second end of the input tube.

58. The system of paragraph 43, wherein the at least one aperture at the second end of the input tube comprises at least one aperture defined by the wall of the input tube at the second end of the input tube.

59. The system of paragraph 43, wherein the at least one aperture at the second end of the input tube is associated with a fitting attachable to the second end of the input tube.

60. The system of paragraph 59, including a first and at least one second fitting interchangeably attachable to the second end of the input tube, the first fitting having at least one aperture of a first size, the at least one second fitting having at least one aperture of a second size.

61. The system of paragraph 43, wherein the diameter of the at least one aperture at the second end of the input tube is sized proportional to a filling rate.

62. The system of paragraph 43, wherein the diameter of the at least one aperture at the second end of the input tube is sized inversely proportional to pressure in the input tube.

63. The system of paragraph 43, further including: a valve positioned between the first end and the second end of the input tube.

64. The system of paragraph 63, wherein the valve positioned between the first end and the second end of the input tube comprises a ball valve with a spring return handle.

65. The system of paragraph 43, wherein the input tube is at least partially covered with an insulation material.

66. The system of paragraph 65, wherein the insulation material comprises a rubberized plastic coating.

67. The system of paragraph 43, wherein the vent tube is formed from at least one of copper, copper alloy, aluminum, stainless steel, or carbon steel.

68. The system of paragraph 43, wherein the vent tube is formed from a plastic or polymer material.

69. The system of paragraph 43, wherein the vent tube is formed from a composite material.

70. The system of paragraph 43, wherein the vent tube is formed from a plastic or polymer material having a glass transition temperature below 0° C.

71. The system of paragraph 43, wherein the lid structure and the vent tube are formed as a single manufactured unit.

72. The system of paragraph 43, wherein the second end of the vent tube is bent at an angle from vertical away from the input tube to deflect the gaseous carbon dioxide.

73. The system of paragraph 43, wherein the second end of the vent tube is bent at about a 15 degree angle to about a 90 degree angle from vertical away from the input tube.

74. The system of paragraph 43, wherein the second end of the vent tube includes at least one deflector positioned to deflect the gaseous carbon dioxide.

75. The system of paragraph 43, wherein the second end of the vent tube includes at least one internal deflector positioned in the flow conduit of the vent tube to deflect the gaseous carbon dioxide.

76. The system of paragraph 43, wherein the second end of the vent tube includes an attachment site for a vent sock or hose.

77. The system of paragraph 43 further including: a vent sock or hose attachable to the second end of the vent tube.

78. The system of paragraph 43, wherein the lower vent tube is formed from a metal or metal alloy.

79. The system of paragraph 43, wherein the lower vent tube is formed from a plastic or polymer material.

80. The system of paragraph 43, wherein the lower vent tube is formed from a composite material.

81. The system of paragraph 43, wherein the lower vent tube is formed from a plastic or polymer material with a glass transition temperature below 0° C.

82. The system of paragraph 43, wherein the lower vent tube is at least partially covered with a porous material, wherein the porous material defines openings sized to at least partially prevent passage of solid carbon dioxide into the interior portion of the lower vent tube and vent tube.

83. The system of paragraph 43, wherein the lower vent tube is at least partially covered with a mesh material, wherein the mesh material defines openings sized to at least partially prevent passage of solid carbon dioxide into the interior portion of the lower vent tube and vent tube.

84. The system of paragraph 83, wherein the mesh material is formed from a metal or metal alloy.

85. The system of paragraph 83, wherein the mesh material is formed from a plastic or polymer material.

86. The system of paragraph 43, further including at least one additional lower vent tube sized to extend into the interior portion of the storage container, the at least one additional lower vent tube having an open first end sized to couple to the first end of the vent tube, a wall of the at least one additional lower vent tube defining a plurality of openings sized to allow passage of the gaseous carbon dioxide from the storage container, through the lower vent tube, and out the vent tube.

87. The system of paragraph 86, wherein the at least one additional lower vent tube includes a mesh or porous layer covering at least a portion of the at least one additional lower vent tube.

88. The system of paragraph 83, wherein the at least one additional lower vent tube is sized for attachment to the second end of the vent tube.

89. The system of paragraph 43, wherein the lower vent tube comprises a storage tube sized to fit entirely within the storage container and to hold at least one removable sample holder, the storage tube having an open first end sized to couple to the first end of the vent tube and a closed second end, a wall of the storage tube defining a plurality of openings sized to allow passage of the gaseous carbon dioxide from the storage container, through the storage tube, and out the vent tube.

90. The system of paragraph 89, further including: at least one additional storage tube.

91. In some embodiments, a device for dry ice production includes: a lid structure and a vent tube formed as a single manufactured unit, wherein the lid structure has a top surface and a bottom surface, the bottom surface sized for placement over an opening to a storage container, the lid structure defining a first opening with a diameter configured to accept an input tube attached to a source of carbon dioxide, and wherein the vent tube defines a second opening through the lid structure and has a first end and a second end forming a flow conduit for gaseous carbon dioxide out of the storage container, the first end of the vent tube extending beyond the bottom surface of the lid structure and sized to fit within the storage container and couple with a lower vent tube, the second end of the vent tube extending beyond the top surface of the lid structure.

92. The device of paragraph 91, wherein the lid structure and the vent tube are formed as a single manufactured unit from a material having a low thermal conductivity value.

93. The device of paragraph 91, wherein the second end of the vent tube extending beyond the top surface of the lid structure is bent at an angle from vertical away from the first opening defined by the lid structure.

94. The device of paragraph 91, further including: the input tube sized to traverse at least partially through the first opening defined by the lid structure, the input tube having a first end and a second end forming a flow conduit for pressurized carbon dioxide into the storage container, the first end of the input tube having a coupling for attachment to the source of carbon dioxide, the second end of the input tube traversing at least partially through the first opening defined by the lid structure and including at least one aperture having a diameter smaller than an inner diameter of the input tube.

95. The device of paragraph 91, further including: a lower vent tube sized to extend into an interior portion of the storage container, the lower vent tube having an open first end sized to couple to the first end of the vent tube, a wall of the lower vent tube defining a plurality of openings sized to allow passage of the gaseous carbon dioxide from the storage container, through the lower vent tube, and out the vent tube.

96. The device of paragraph 95, wherein the lower vent tube comprises a storage tube sized to fit entirely within the storage container and to hold at least one removable sample holder, the storage tube having an open first end sized to couple to the first end of the vent tube and a closed second end, a wall of the storage tube defining a plurality of openings sized to allow passage of the gaseous carbon dioxide from the storage container, through the storage tube, and out the vent tube.

97. In some embodiments, a system for dry ice production includes: a lid structure sized for placement over an opening to a storage container, the lid structure defining an opening; a vent tube sized to pass through and seal within the opening defined by the lid structure, the vent tube having a first end and a second end forming a flow conduit for gaseous carbon dioxide, the first end of the vent tube sized to fit into the opening to the storage container; a lower vent tube sized to extend into an interior portion of the storage container, the lower vent tube having a first end sized to couple to the first end of the vent tube, and a wall of the lower vent tube defining a plurality of openings sized to allow passage of the gaseous carbon dioxide from the storage container, through the lower vent tube, and out the vent tube; and an input tube sized to traverse through an interior portion of the vent tube, the input tube having a first end and a second end forming a flow conduit for pressurized carbon dioxide into the storage container, the first end of the input tube having a coupling for attachment to a source of carbon dioxide, the second end of the input tube sized to extend beyond a second end of the lower vent tube and including at least one aperture having a diameter smaller than an inner diameter of the input tube.

98. In some embodiments, a device for dry ice production includes: a lid structure having a top surface and a bottom surface, the bottom surface of the lid structure sized for placement over an opening to a storage container, the lid structure defining a first opening and a second opening, the first opening forming a flow conduit through the lid structure from the top surface to the bottom surface, the first opening having at or near the top surface of the lid structure an attachment site for an input tube attached to a source of carbon dioxide, wherein an inner diameter of the first opening at or near the bottom of the lid structure is smaller than an inner diameter of the first opening at or near the top surface of the lid structure; and a vent tube sized to pass through and seal within the second opening defined by the lid structure, the vent tube having a first end and a second end forming a flow conduit for gaseous carbon dioxide, the first end of the vent tube sized to fit into the opening to the storage container.

99. The device of paragraph 98, wherein the lid structure is formed from a material of sufficient strength and thickness to withstand operational pressures of up to 1000 psi.

100. The device of paragraph 98, wherein the lid structure and the vent tube are formed as a single manufactured unit, the vent tube defining the second opening through the lid structure, the first end and the second end of the vent tube forming the flow conduit for the gaseous carbon dioxide out of the storage container, the first end of the vent tube extending beyond the bottom surface of the lid structure and sized to fit within the storage container, the second end of the vent tube extending beyond the top surface of the lid structure.

101. The device of paragraph 98, further including: a lower vent tube sized to extend into an interior portion of the storage container, the lower vent tube having an open first end sized to couple to the first end of the vent tube, a wall of the lower vent tube defining a plurality of openings sized to allow passage of the gaseous carbon dioxide from the storage container, through the lower vent tube, and out the vent tube.

One skilled in the art will recognize that the herein described components, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity. The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “operably coupled to” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components can be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications can be made without departing from the subject matter described herein and its broader aspects and, therefore, the appended claims are to encompass within their scope all such changes and modifications as are within the true spirit and scope of the subject matter described herein.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A device for dry ice production, comprising:
a lid structure sized for placement over an opening to a storage container, the lid structure defining a first opening and a second opening;
an input tube sized to traverse at least partially through the first opening defined by the lid structure, the input tube having a first end and a second end forming a flow conduit for pressurized carbon dioxide into the storage container, the first end of the input tube having a coupling for attachment to a source of carbon dioxide, the second end of the input tube traversing at least partially through the first opening defined by the lid structure and including at least one aperture having a diameter smaller than an inner diameter of the input tube; and
a vent tube sized to pass through and seal within the second opening defined by the lid structure, the vent tube having a first end and a second end forming a flow conduit for gaseous carbon dioxide out of the storage container, the first end of the vent tube sized to fit within the storage container and to couple with a lower vent tube.

2. (canceled)

3. The device of claim 1, wherein the lid structure is formed from at least one of a plastic, polymer, or composite material having a low thermal conductivity value.

4.-8. (canceled)

9. The device of claim 1, wherein the lid structure includes a lower portion sized to fit into the opening of the storage container wherein the storage container includes a vacuum insulated storage container.

10. The device of claim 1, wherein the input tube is formed from a material with at least one of a strength or a wall thickness sufficient to withstand operational pressures of up to 1000 psi.

11. (canceled)

12. The device of claim 1, further comprising:
at least one second first opening defined by the lid structure and at least one second input tube sized to traverse at least partially through the at least one second first opening defined by the lid structure, the at least one second input tube having a first end and a second end forming a flow conduit for pressurized carbon dioxide into the storage container, the first end of the at least one second input tube having a coupling for attachment to a source of carbon dioxide, the second end of the at least one second input tube traversing at least partially through the at least one second first opening defined by the lid structure and including at least one aperture having a diameter smaller than an inner diameter of the at least one second input tube.

13. The device of claim 1, wherein the at least one aperture at the second end of the input tube comprises a single aperture at the extreme end of the second end of the input tube.

14. The device of claim 1, wherein the at least one aperture at the second end of the input tube comprises an array of two or more apertures at the extreme end of the second end of the input tube.

15. The device of claim 1, wherein the at least one aperture at the second end of the input tube comprises at least one aperture defined by a wall of the input tube at the second end of the input tube.

16. The device of claim 1, wherein the at least one aperture at the second end of the input tube is associated with a fitting attachable to the second end of the input tube.

17. The device of claim 1, wherein the diameter of the at least one aperture at the second end of the input tube is sized proportional to a filling rate.

18. The device of claim 1, wherein the diameter of the at least one aperture at the second end of the input tube is sized inversely proportional to pressure in the input tube.

19. The device of claim 1, further comprising:
a valve positioned between the first end and the second end of the input tube.

20.-25. (canceled)

26. The device of claim 1, wherein the vent tube is formed from a plastic or polymer material with a glass transition temperature below 0° C.

27. (canceled)

28. The device of claim 1, wherein the second end of the vent tube is bent at an angle from vertical away from the input tube to deflect the gaseous carbon dioxide.

29. The device of claim 1, wherein the second end of the vent tube is bent at about a 15 degree angle to about a 90 degree angle from vertical away from the input tube.

30. The device of claim 1, wherein the second end of the vent tube includes at least one deflector positioned to deflect the gaseous carbon dioxide.

31. The device of claim 1, wherein the second end of the vent tube includes at least one internal deflector positioned in the flow conduit of the vent tube to deflect the gaseous carbon dioxide.

32. The device of claim 1, wherein the second end of the vent tube includes an attachment site for a vent sock or hose.

33. The device of claim 1, further comprising:
a lower vent tube sized to extend within an interior portion of the storage container, the lower vent tube having an open first end sized to couple to the first end of the vent tube, a wall of the lower vent tube defining a plurality of openings sized to allow passage of the gaseous carbon dioxide from the storage container, through the lower vent tube, and out the vent tube.

34. The device of claim 33, wherein the lower vent tube comprises a storage tube sized to fit entirely within the storage container and to hold at least one removable sample holder, the storage tube having an open first end sized to couple to the first end of the vent tube and a closed second end, a wall of the storage tube defining a plurality of openings sized to allow passage of the gaseous carbon dioxide from the storage container, through the storage tube, and out the vent tube.

35.-38. (canceled)

39. The device of claim 33, wherein the lower vent tube is at least partially covered with a porous or mesh material, wherein the porous or mesh material defines openings sized to at least partially prevent passage of solid carbon dioxide flakes into the interior portion of the lower vent tube and the vent tube.

40.-42. (canceled)

43. A system for dry ice production, comprising:
a lid structure sized for placement over an opening to a storage container, the lid structure defining a first opening and a second opening;
an input tube sized to traverse at least partially through the first opening defined by the lid structure, the input tube having a first end and a second end forming a flow conduit for pressurized carbon dioxide into the storage container, the first end of the input tube having a coupling for attachment to a source of carbon dioxide, the second end of the input tube traversing at least partially through the first opening defined by the lid structure and including at least one aperture having a diameter smaller than an inner diameter of the input tube;
a vent tube sized to pass through and seal within the second opening defined by the lid structure, the vent tube having a first end and a second end forming a flow conduit for gaseous carbon dioxide, the first end of the vent tube sized to fit into the storage container; and
a lower vent tube sized to extend into an interior portion of the storage container, the lower vent tube having an open first end sized to couple to the first end of the vent tube, a wall of the lower vent tube defining a plurality of openings sized to allow passage of the gaseous carbon dioxide from the storage container, through the lower vent tube, and out the vent tube.

44.-50. (canceled)

51. The system of claim 43, further comprising a vacuum insulated storage container, wherein the lid structure is sized for placement over an opening to the vacuum insulated storage container.

52.-54. (canceled)

55. The system of claim 43, further comprising:
at least one second first opening defined by the lid structure and at least one second input tube sized to traverse at least partially through the at least one second first opening defined by the lid structure, the at least one second input tube having a first end and a second end forming a flow conduit for pressurized carbon dioxide into the storage container, the first end of the at least one second input tube having a coupling for attachment to a source of carbon dioxide, the second end of the at least one second input tube traversing at least partially through the at least one second first opening defined by the lid structure and including at least one aperture having a diameter smaller than an inner diameter of the at least one second input tube.

56.-58. (canceled)

59. The system of claim 43, wherein the at least one aperture at the second end of the input tube is associated with a fitting attachable to the second end of the input tube.

60. The system of claim 59, including a first and at least one second fitting interchangeably attachable to the second end of the input tube, the first fitting having at least one aperture of a first size, the at least one of the second fitting having at least one aperture of a second size.

61.-62. (canceled)

63. The system of claim 43, further comprising:
a valve positioned between the first end and the second end of the input tube.

64.-71. (canceled)

72. The system of claim 43, wherein the second end of the vent tube is bent at an angle from vertical away from the input tube to deflect the gaseous carbon dioxide.

73. (canceled)

74. The system of claim 43, wherein the second end of the vent tube includes at least one deflector positioned to deflect the gaseous carbon dioxide.

75.-76. (canceled)

77. The system of claim 43, further comprising:
a vent sock or hose attachable to the second end of the vent tube.

78.-81. (canceled)

82. The system of claim 43, wherein the lower vent tube is at least partially covered with a porous or mesh material, wherein the porous or mesh material defines openings sized to at least partially prevent passage of solid carbon dioxide flakes into the interior portion of the lower vent tube and the vent tube.

83.-85. (canceled)

86. The system of claim 43, further comprising:
at least one additional lower vent tube sized to extend into the interior portion of the storage container, the at least one additional lower vent tube having an open first end sized to couple to the first end of the vent tube, a wall of the at least one additional lower vent tube defining a plurality of openings sized to allow passage of the gaseous carbon dioxide from the storage container, through the lower vent tube, and out the vent tube.

87.-90 (canceled)

91. A device for dry ice production, comprising:
a lid structure and a vent tube formed as a single manufactured unit,
wherein the lid structure has a top surface and a bottom surface, the bottom surface sized for placement over an opening to a storage container, the lid structure defining a first opening with a diameter configured to accept an input tube attached to a source of carbon dioxide, and
wherein the vent tube defines a second opening through the lid structure and has a first end and a second end forming a flow conduit for gaseous carbon dioxide out of the storage container, the first end of the vent tube extending beyond the bottom surface of the lid structure and sized to fit within the storage container and couple with a lower vent tube, the second end of the vent tube extending beyond the top surface of the lid structure.

92. (canceled)

93. The device of claim 91, wherein the second end of the vent tube extending beyond the top surface of the lid structure is bent at an angle from vertical away from the first opening defined by the lid structure.

94. The device of claim 91, further comprising:
the input tube sized to traverse at least partially through the first opening defined by the lid structure, the input tube having a first end and a second end forming a flow conduit for pressurized carbon dioxide into the storage container, the first end of the input tube having a coupling for attachment to the source of carbon dioxide, the second end of the input tube traversing at least partially through the first opening defined by the lid structure and including at least one aperture having a diameter smaller than an inner diameter of the input tube; and
a lower vent tube sized to extend into an interior portion of the storage container, the lower vent tube having an open first end sized to couple to the first end of the vent tube, a wall of the lower vent tube defining a plurality of openings sized to allow passage of the gaseous carbon dioxide from the storage container, through the lower vent tube, and out the vent tube.

95.-97. (canceled)

98. A device for dry ice production, comprising:
a lid structure having a top surface and a bottom surface, the bottom surface of the lid structure sized for placement over an opening to a storage container, the lid structure defining a first opening and a second opening, the first opening forming a flow conduit through the lid structure from the top surface to the bottom surface, the first opening having at or near the top surface of the lid structure an attachment site for an input tube attached to a source of carbon dioxide, wherein an inner diameter of the first opening at or near the bottom surface of the lid structure is smaller than an inner diameter of the first opening at or near the top surface of the lid structure; and
a vent tube sized to pass through and seal within the second opening defined by the lid structure, the vent tube having a first end and a second end forming a flow conduit for gaseous carbon dioxide, the first end of the vent tube sized to fit into the opening to the storage container.

99. (canceled)

100. The device of claim 98, wherein the lid structure and the vent tube are formed as a single manufactured unit, the vent tube defining the second opening through the lid structure, the first end and the second end of the vent tube forming the flow conduit for the gaseous carbon dioxide out of the storage container, the first end of the vent tube extending beyond the bottom surface of the lid structure and sized to fit within the storage container, the second end of the vent tube extending beyond the top surface of the lid structure.

101. The device of claim 98, further comprising:
a lower vent tube sized to extend into an interior portion of the storage container, the lower vent tube having an open first end sized to couple to the first end of the vent tube, a wall of the lower vent tube defining a plurality of openings sized to allow passage of the gaseous carbon dioxide from the storage container, through the lower vent tube, and out the vent tube.
